(19) United States
(12) Patent Application Publication
(10) Pub. No.: US 2009/0111433 A1
(43) Pub. Date: Apr. 30, 2009

(54) Method, System, and Program for Transmission of Multimedia Data

(75) Inventors: Ahti Muhonen, Hirvihaara (FI); Juha H. Salo, Littoinen (FI); Janne La. Aaltonen, Turku (FI); Janne Antola, Laitila (FI); Ari Pajusalo, Helsinki (FI); Ari Hannikainen, Lempaala (FI); Tapio Hameen-Anttila, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/922,782

(22) PCT Filed: Jun. 24, 2005
(86) PCT No.: PCT/IB2005/001798

§ 371 Date: Feb. 29, 2008

(51) Int. Cl. H04M 3/42

(52) U.S. Cl. 455/414.1

(57) ABSTRACT

A method and system for transmitting (10) a multimedia message, wherein a multimedia message to be transmitted is processed by dividing the multimedia message into at least a first message portion and a second message portion. The first message portion is transmitted to a multimedia message service control element (70), and the second message portion is transmitted to a media charger server element (50). A receiver terminal (20) is notified about the transmission of the multimedia message. The transmission of the first message portion from the multimedia message service control element (70) to the receiver terminal (20) is requested, and the transmission of the second message portion from the media charger server (50) element to the receiver terminal (20) is requested. At the receiver terminal (20) the first message portion and the second message portion are combined for obtaining the multimedia message transmitted.

### BACKGROUND OF THE INVENTION

1. Field of the Invention

The present invention relates to a mechanism for transmitting multimedia data via a communication network. In particular, the present invention relates to a system, a sender terminal device, a receiver terminal device, a multimedia message server control element, a multimedia service system for transmitting multimedia messages via a communication network, corresponding methods and computer program products.

For the purpose of the present invention to be described herein below, it should be noted that
a network element acting as a communication device or terminal device may for example be any device by means of which a user may access a communication network; this implies mobile as well as non-mobile devices and networks, independent of the technology platform on which they are based; only as an example, it is noted that terminal devices and network elements operated according to principles standardized by the 3^{rd} Generation Partnership Project 3GPP and known for example as UMTS elements are particularly suitable for being used in connection with the present invention, but also terminal devices and network elements working according to a different standard, such as GSM (Global System for Mobile communications), can apply the present invention;
a network element can act as a client entity (terminal device) or as a server entity (multimedia message service control element, media charger server element) in terms of the present invention, or may even have both functionalities integrated therein;
a content of communications, in particular related to multimedia messages, via a traffic channel may comprise at least one of audio data, video data, image data, text data, and meta data descriptive of attributes of the audio, video, image and/or text data, any combination thereof or even, alternatively or additionally, other data such as, as a further example, program code of an application program to be accessed/downloaded;
method steps likely to be implemented as software code portions and being run using a processor at one of the server/client entities are software code independent and can be specified using any known or future developed programming language;
method steps and/or devices likely to be implemented as hardware components at one of the server/client entities are hardware independent and can be implemented using any known or future developed hardware technology or any hybrids of these, such as MOS, CMOS, BiCMOS, ECL, TTL, etc, using for example ASIC components or DSP components, as an example;
generally, any method step is suitable to be implemented as software or by hardware without changing the idea of the present invention;
devices or network elements can be implemented as individual devices, but this does not exclude that they are implemented in a distributed fashion throughout the system, as long as the functionality of the device is preserved.

2. Related Prior Art

In the recent years, an increasing expansion of communication networks, e.g. of wire based communication networks, such as the Integrated Services Digital Network (ISDN), or wireless communication networks, such as the cdma2000 (code division multiple access) system, cellular 3^{rd} generation communication networks like the Universal Mobile. Telecommunications System (UMTS), the General Packet Radio System (GPRS), or other wireless communication system, such as the Wireless Local Area Network (WLAN), took place all over the world. Various organizations, such as the 3^{rd} Generation Partnership Project (3GPP), the International Telecommunication Union (ITU), 3^{rd} Generation Partnership Project 2 (3GPP2), Internet Engineering Task Force (IETF), and the like are working on standards for telecommunication networks and multiple access environments.

In general, the system structure of a communication network is such that one party, e.g. a subscriber's terminal equipment, such as a mobile station, a mobile phone, a fixed phone, a personal computer (PC), a laptop, a personal digital assistant (PDA) or the like, is connected via transceivers and interfaces, such as an air interface or the like, to an access network subsystem. The access network subsystem controls the communication connection to and from the user equipment and is connected via an interface to at least one corresponding core or backbone network subsystem. The core (or backbone) network subsystem switches the data transmitted via the communication connection to a destination party, such as another user equipment, a service provider (server/proxy), or another communication network. It is to be noted that the core network subsystem may be connected to a plurality of access network subsystems. Depending on the used communication network, the actual network structure may vary, as known for those skilled in the art and defined in respective specifications, for example, for UMTS, GPRS, GSM and the like.

Generally, for properly establishing and handling a communication connection between network elements such as the user equipment and another user terminal, a database, a server, etc., one or more intermediate network elements such as control network elements, support nodes or service nodes are involved.

While the transmission of voice communication represents one important service provided by communication networks, there are several developments of improved services providing advanced functions and capabilities for the users. Such improved services comprises, for example, massaging, e-mail transfer, Internet browsing, access to a plurality of applications and services provided by service providers and the like. One example for such an improved service is the multimedia message service (MMS) which is also applicable in connection with wireless communication networks.

MMS represents a successor to the short message service (SMS) and is a service for terminals, in particular wireless terminals like mobile phones or the like, which enables the user to send multimedia content such as images, sounds, together with text messages, data and the like. Since current mobile phones provide also a digital camera function, it is more and more attractive to take photos and send to other subscribers.

FIG. 14 shows a block diagram of a structure of a conventional mobile communication network, for example a GSM/GPRS based or UMTS based network, in which a multimedia message is transmitted. The network comprises base station subsystems (BSS) 31 and 32 which are connected with a circuit switched core network 30 comprising a mobile switching centre (MSC), a visitor location register (VLR) and a home location register (HLR), for example. Furthermore, there is provided a packet switched core or backbone network (CN/BB) based on GPRS 40 to which the BSS 31, 32 are connected. The GPRS CN/BB comprises several network elements (not shown), such as a SGSN, a GGSN and the like for controlling and relaying communications. A short message service center (SMSC) 35 as a control element for a short message service is also connected to the MSC/VLR/HLR 30. Furthermore, wireless application protocol (WAP) gateway or a push proxy gateway (PPG) 1060 for relaying WAP signalling between network elements is provided in an IP environment. WAP is a standard protocol for the presentation and delivery of wireless information and telephony services on mobile phones and other (wireless) terminals. Furthermore, a multimedia message service center (MMSC) 1070 as a multimedia message service control element is provided which is connected with the WAP gateway 1060 and controls the transmission of multimedia messages in the communication network. In addition, the MMSC 1070 provides an application interface and a connection to other external applications (EA) or services, such a e-mail, the Internet, other MMSCs in different networks and the like, via a HTTP or SMTP interface. Further details of the MMS system architecture and functions are known to those skilled in the art and can be found in the respective specifications, for example.

When a multimedia message is to be transmitted, for example, from a sender terminal 1010 to a receiver terminal 1020 in the system according to FIG. 14, a signalling as shown in FIG. 15 is executed. Generally, from the network perspective, the MMSC is needed to perform the required store and forward operations of multimedia messages. The message flow in the GPRS network is described in the following. A multimedia message (MM) is sent from the sender terminal (subscriber A) to the MMSC by using a WAP POST operation via the WAP gateway (messages M1001, M1002). The message comprises the content of the MM and the MSISDN (Mobile Subscriber Integrated Services Digital Network number). The MMSC checks to which target the MM is directed. In the present case, it is assumed that the destination is the receiver terminal in the same network, while it is also possible to direct the MM to e-mail systems, at external applications or another MMSC. For the delivery of the MM from MMSC to the receiver terminal, a WAP PUSH operation is executed (message M1006) by means of which a notification is transmitted (message M1004, M1005) from the MMSC to the receiver terminal via SMS (i.e. the SMSC 35 in FIG. 14). After receiving the notification the receiver terminal (subscriber B) sends a WAP GET request to the MMSC via the WAP gateway (messages M1006, M1007). In the response the MM is delivered from the MMSC to the receiver terminal (messages M1008, M1009) and the MM can be displayed. The downloading process is invisible to the end user and the user is notified when the whole message is downloaded and put in the memory, such as a MMS inbox.

In other words, the MM is sent from the sender terminal 1010 by using standard Internet protocols. When the sending of the message is initiated by the user, the sender terminal 1010 communicates with the WAP gateway 1060 via the BSS 31 and GPRS CN/BB 40. The WAP gateway may translate WAP POST into a HTTP POST towards the MMSC 1070. The MMSC is the interface and router in the system and stores MM in its database (memory) and can access them. Then it decodes the message to find its destination address. The destination can be an email address or a phone number. Then the MMC transmits a notification to the receiver terminal 1020 with the help of the WAP gateway 1060. This can be done in two ways, i.e. over SMS or over IP, wherein the common way to do it is over SMS. The WAP gateway 1060 now transmits an SMS telling the receiver terminal 1020 that it has an MM to get. The receiver terminal 1020 downloads it from the MMSC using WAP GET which is translated, for example, to a regular HTTP GET by the WAP GW before it reaches the MMSC.

A different development for enhancing services of communication networks is a so-called multimedia content delivery service concept, also called media charger service concept. Media charger service builds on an efficient delivery of large content files to mobile phones based on subscriptions. The media charger concept utilizes network resources efficiently and provides the consumers with a pleasant user experience. In the media charger service, content is organized into content channels, to which the consumers are able to subscribe based on their personal interests. To make the service as fluent as possible from the end-user perspective, the content delivery process is highly automated: files are automatically delivered to the client application in the consumers' handsets as new content is published in the server. The service can also be configured to focus the file downloads on a certain time window, for example, to enable a service model, in which file transfers take place only during off-peak hours of the underlying network. After receiving a piece of content, a consumer can consume it wherever and whenever he wants to. The media charger service operates over cellular packet networks. The system is basically content type independent. Based on the service configuration, charging can be performed in two different ways (i.e. based on CDRs (Charging Data Record) or using SMS (Short Message Service)). FIG. 12 shows a general architecture of a media charger concept.

As shown in FIG. 12, the media charger system is based on the client-server architecture. An example for such a media charger system is for example the Media Charger System 3.0 provided by Nokia. The client application 503 resides in a consumer's mobile handset and communicates with a multimedia content control server or multimedia content control element which is referred to hereinafter as a media charger server 500 using Hypertext Transfer Protocol (HTTP) over packet connection. The system is not tied to any specific access technology and therefore, for example, GPRS, EDGE, and WCDMA can be used. The multimedia content control server, i.e. the media charger server 500 is the main part of the media charger system. The server, which is operated by a media charger administrator, provides interfaces to mobile consumers to interact with the server system. Based on the system configuration, the communication between the server and clients can be performed using HTTP access, or in the second alternative also SMS (Short Message Service) access may be used together with packet connectivity. Content delivery is the core function, which the whole media charger concept is built on. Through this process the content files, provided by a content source 501, are transmitted from the media charger server to subscribers' terminals. The content delivery process is completely transparent to the consumer. The media charger client 503 takes care of automatically retrieving new content items from the server as the items become available. To perform this, the client may periodically contact the server to check whether new items are available on the subscribed channels. This process is called periodic polling. As a response, the server tells the client to download new content if available and possibly also tells the client to remove some old content items to free enough memory space for the new ones. The client acts upon these instructions and therefore the content available in the terminal becomes updated. If the content item downloading process becomes interrupted for some reason, the media charger client 503 may have in-built intelligence to continue downloading from the point of interruption and thus make the downloading more efficient. The delivery process may be completely automated in the media charger client thus giving a pleasant user experience to the end-users.

A HTTP access interface enables the HTTP-based communication between the media charger server 500 and clients. This interface is used for delivery of content and related control messages. Clients poll periodically updates to channel hierarchy/item information via this interface. As a reply, the download server instructs the client to download the correct content files (on the subscribed channels) and to remove the old content files from the terminal if necessary. Content downloading is performed using a pull mechanism: the client requests content downloading from the server. The download server 500 includes support for recovering from interrupted download sessions. To ensure only legal clients have access to the service, a subscriber is authenticated whenever his client communicates with the server. The communication may be performed with XML-based protocol over HTTP (or HTTPS depending on the configuration).

In FIG. 13, a signalling diagram for the media charger system according to FIG. 12 is shown. The FIGURE describes content download from Media Charger (MC) server to a MC client in a user terminal. First, MC server transmits service instructions to the client. The service instructions may be transmitted from the MC server which describe, for example, a content, a content type, a content name, a content size, a content partition/ranges, a download time frame, etc. According to the instructions the client sends to the server a HTTP GET request for a content X and its partition/range 1-n. This will be repeated as many times as is needed for the whole content download (1 to n times). After having successful download the content the client may sends an OK signal to the server. In the case there happens a failure in the content download, i.e. the client does not get a data packet (RANGE 1-n), fully or partially, it has requested, the client will send a new request for the same data packet (RANGE 1-n) to the server. This may happen a certain number of times or a certain time period. It is to be noted that a content upload from the MC client to the MC server is executed in a similar way as described above, except signalling will executed vice versa.

In U.S. patent application Ser. No. 10/803,684 a media and recovery system is disclosed which is similar to the media charger system described above.

As mentioned above, the MMS is used to transmit multimedia messages between sender and receiver. However, in the currently existing MMS systems, it is only possible to send files in range of few hundred kilobytes, and the size is not going up to mega bytes fast, or over 10 MB. Since the size of MMS messages to be transmitted will increase, for example due to the increased quality and thus size of pictures to be transmitted, such a limitation of the data size may affect service quality adversely.

### SUMMARY OF THE INVENTION

It is an object of the invention to provide an improved system, a sender terminal device, a receiver terminal device, a multimedia message server control element, a multimedia service system for transmitting multimedia messages via a communication network, as well as corresponding methods and computer program products by means of which the transmission of large multimedia messages, i.e. of messages having a larger data size, is possible.

This object is achieved by the measures defined in the attached claims.

In particular, according to one aspect of the proposed solution, there is provided, for example, a method of transmitting a multimedia message, comprising the steps of processing a multimedia message to be transmitted by dividing the multimedia message into at least a first message portion and a second message portion, transmitting the first message portion to a multimedia message service control element, transmitting the second message portion to a media charger server element, notifying a receiver terminal about the transmission of the multimedia message, requesting the transmission of the first message portion from the multimedia message service control element to the receiver terminal and requesting the transmission of the second message portion from the media charger server element to the receiver terminal.

Furthermore, according to one aspect of the proposed solution, there is provided, for example, a system for transmitting a multimedia message, the system comprising sender terminal comprising a media charger proxy functional means which is configured to process a multimedia message to be transmitted by dividing the multimedia message into at least a first message portion and a second message portion, a multimedia message service control element configured to receive the first message portion, a media charger server element configured to receive the second message portion, a message transmission system configured to notify a receiver terminal about the transmission of the multimedia message, wherein the receiver terminal comprises a media charger proxy functional means which is configured to perform at least one of requesting the transmission of the first message portion from the multimedia message service control element to the receiver terminal and requesting the transmission of the second message portion from the media charger server element to the receiver terminal.

According to further refinements, the proposed solution may comprise one or more of the following features:
the processing of the multimedia message may further comprise a generation of a unique identifier for the multimedia message and a provision of each of the first and second message portions with the unique identifier;
the notification of the receiver terminal may be executed when the first message portion is received by the multimedia message service control element; alternatively, the notification of the receiver terminal may be executed when the second message portion is received by the media charger server element;
at the receiver terminal, the first message portion may be received before the requesting of the second message portion, and the first message portion and the second message portion may be combined for obtaining the multimedia message transmitted, for example on the basis of the unique identifier included in each of the first message portion and the second message portion;
the combination of the first message portion and the second message portion may be executed by a media charger proxy functionality included in the receiver terminal;
the requesting of the transmission of the first and the second message portions may be executed by a media charger proxy functionality included in the receiver terminal;
the processing may further comprise a check whether a predetermined condition is fulfilled for the multimedia message to be transmitted, wherein the division of the multimedia message, and possibly the generation and provision of the unique identifier, may be inhibited when the predetermined condition is not fulfilled;
the processing may be executed by a media charger proxy functionality in a sender terminal;
the first message portion may include a header indicating communication information, obtained from the multimedia message, comprising at least one of a written message part, a media charger tag, a network address of the media charger server element and a unique identifier;
the second message portion may include at least one of content data of the multimedia message and a unique identifier;
at least one of the transmission of the first message portion, the transmission of the second message portion and the notification of the receiver terminal may be effected at least in part by using an IP based communication path;
the transmissions of the first message portion and the second message portion may be based at least in part on a transmission path including a wireless application protocol;
the notification of the receiver terminal may include at least in part a transmission via a transmission path including a short message service signaling;
the multimedia message service control element and the media charger server element may be included in one server entity;
alternatively, the notification of the receiver terminal may comprise a transmission of a unique identifier and/or a network address of the media charger server element to a media charger proxy functionality in the receiver terminal; then the requesting of the first message portion and the requesting of the second message portion may be executed simultaneously; alternatively, the requesting of the second message portion may be executed prior to the requesting of the first message portion, wherein the requesting of the first message portion may be executed by the media charger server element after receiving an information on the multimedia message service control element with the request for the second message portion from the receiver terminal;
alternatively, the requesting of the second message portion may be executed by the multimedia message service control element after receiving the request for the first message portion from the receiver terminal;
alternatively, the first message portion may be transmitted together with the second message portion to the media charger server element, wherein the transmission of the first message portion to the multimedia message server control element may be executed by the media charger server element; then, the media charger server element may comprise a media charger proxy functionality.

Moreover, according to one aspect of the proposed solution, there is provided, for example, a method of transmitting a multimedia message, comprising the steps of processing a multimedia message to be transmitted, generating and providing a unique identifier for the multimedia message, transmitting the multimedia message to a media charger server element, transmitting the multimedia message to a multimedia message service control element, notifying a receiver terminal about the transmission of the multimedia message when the multimedia message is received by the multimedia message service control element, requesting the transmission of the multimedia message from the media charger server element to the receiver terminal obtaining the multimedia message from the multimedia message service control element at the media charger server element, and transmitting the multimedia message from the media charger server element to the receiver terminal. There is also provided a corresponding system for transmitting a multimedia message.

According to further refinements of this aspect of the invention, the proposed solution may comprise one or more of the following features:
the processing may further comprise a check whether a predetermined condition is fulfilled for the multimedia message to be transmitted, wherein the transmission of the multimedia message to the media charger server element and the generation and provision of the unique identifier may be inhibited when the predetermined condition is not fulfilled;
the generation and provision of the unique identifier for the multimedia message may be executed by one of a media charger proxy functionality of a sender terminal, the media charger server element and the multimedia message service control element.

Furthermore, according to one aspect of the proposed solution, there is provided, for example, a terminal device configured to send a multimedia message in a communication system, the communication system comprising a multimedia message service control element and a media charger server element, wherein the terminal device comprises a media charger proxy functional means which is configured to process the multimedia message to be transmitted by dividing the multimedia message into at least a first message portion and a second message portion, to transmit the first message portion to the multimedia message service control element, and to transmit the second message portion to the media charger server element. There are also provided a corresponding method and a corresponding computer program product.

According to further refinements of this aspect, the proposed solution may comprise one or more of the following features:
the media charger proxy functionality may be further configured to process the multimedia message by generating a unique identifier for the multimedia message and providing each of the first and second message portions with the unique identifier;
the media charger proxy functional means of the terminal may be further configured to check whether a predetermined condition is fulfilled for the multimedia message to be transmitted, wherein the division of the multimedia message, and possibly the generation and provision of the unique identifier, is inhibited when the predetermined condition is not fulfilled;
the predetermined condition may comprise a predefined threshold for a size of the multimedia message;
the first message portion may include a header indicating communication information, obtained from the multimedia message, comprising at least one of a written message part, a media charger tag, a network address of the media charger server element and a unique identifier;
the second message portion may include at least one of content data of the multimedia message and a unique identifier;
the terminal may be configured to transmit, at least in part, at least one of the first message portion and the second message portion via an IP based communication path;
the terminal may be configured to transmit at least one of the first message portion and the second message portion at least in part via a transmission path including a wireless application protocol.

In addition, according to one aspect of the proposed solution, there is provided, for example, a terminal device configured to receive a multimedia message in a communication system, the communication system comprising a multimedia message service control element, a media charger server element, and a message transmission system, wherein the terminal device comprises a media charger proxy functional means which is configured to receive a notification of the message transmission system about the transmission of a multimedia message, to request the transmission of a first message portion from the multimedia message service control element, to request the transmission of a second message portion from the media charger server element to the receiver terminal, and to combine the first message portion and the second message portion for obtaining the multimedia message transmitted (for example on the basis of a unique identifier included in each of the first message portion and the second message portion). Furthermore, there are also provided a corresponding method and a corresponding computer program product.

According to further refinements of this aspect, the proposed solution may comprise one or more of the following features:
each of the first message portion and the second message portion may include a unique identifier;
the media charger proxy functional means of the terminal device may be configured to perform requesting the second message portion after the first message portion is received;
the first message portion may include a header indicating communication information, obtained from the multimedia message, comprising at least one of a written message part, a media charger tag, a network address of the media charger server element and a unique identifier;
the second message portion may include at least one of content data of the multimedia message and a unique identifier;
the terminal device may be configured to receive, at least in part, at least one of the first message portion, the second message portion and the notification about the multimedia message via an IP based communication path;
the terminal device may be configured to receive at least one of the first message portion and the second message portion at least in part via a transmission path including a wireless application protocol;
the terminal device may be configured to receive at least in part the notification about the multimedia message via a transmission path including a short message service signaling;
the terminal device may be configured to display the transmitted multimedia message on the basis of the first message portion and the second message portion received.

Moreover, according to one aspect of the proposed solution, there is provided, for example, a multimedia message service control element of a communication system for transmitting a multimedia message, the communication system comprising a sender terminal comprising a media charger proxy functional means, a receiver terminal comprising a media charger proxy functional means, a media charger server element, and a message transmission element, wherein the multimedia message service control element is configured to receive from the sender terminal a first message portion related to the multimedia message, to notify, via the message transmission system, the receiver terminal about the transmission of the multimedia message, to receive a request from the receiver terminal for transmitting the first message portion, and to transmit the first message portion related to the multimedia message to the receiver terminal. There are also provided a corresponding method and a corresponding computer program product.

According to further refinements of this aspect, the proposed solution may comprise one or more of the following features:
the notification of the receiver terminal may be executed when the first message portion is received by the multimedia message service control element; alternatively, the notification of the receiver terminal may be executed when the multimedia message service control element receives an information from the media charger server element that the media charger server element has received a second message portion;
the first message portion may include a header indicating communication information, obtained from the multimedia message, comprising at least one of a written message part, a media charger tag, a network address of the media charger server element and a unique identifier;
the multimedia message service control element may be configured to use, at least in part, an IP based communication path for at least one of transmitting the first message portion and notifying the receiver terminal;
the multimedia message service control element may be configured to use at least in part a transmission path including a wireless application protocol for transmitting the first message portion;
the multimedia message service control element may be configured to use at least in part a transmission path including a short message service signaling for notifying the receiver terminal;

In addition, according to one aspect of the proposed solution, there is provided, for example, a multimedia service system for transmitting a multimedia message in a communication system, the communication system comprising a sender terminal comprising a media charger proxy functional means and a receiver terminal comprising a media charger proxy functional means, wherein the multimedia service system comprises a media charger server element, a multimedia message service control element and a message transmission element, wherein the multimedia service system is configured to receive from the sender terminal a first message portion at the multimedia message service control element and a second message portion at the media charger server element, the first and second message portions being related to the multimedia message, to notify, via the message transmission system, the receiver terminal about the transmission of the multimedia message, to receive, at the multimedia message service control element, a request from the receiver terminal for transmitting the first message portion, to transmit the first message portion related to the multimedia message and comprising the unique identifier to the receiver terminal, to receive, at the media charger server element, a request from the receiver terminal for transmitting the second message portion, and to transmit the second message portion related to the multimedia message to the receiver terminal. There are also provided a corresponding method and a corresponding computer program product.

According to further refinements of this aspect, the proposed solution may comprise one or more of the following features:
each of the first and second message portions may comprise a unique identifier for the multimedia message;
the notification of the receiver terminal may be executed when the first message portion is received by the multimedia message service control element; alternatively, the media charger server element may configured to send an information to the multimedia message service control element that the second message portion is received, and the multimedia message service control element may be configured to notify the receiver terminal when multimedia message service control element receives the information from the media charger server element that the media charger server element has received the second message portion;
the first message portion may include a header indicating communication information, obtained from the multimedia message, comprising at least one of a written message part, a media charger tag, a network address of the media charger server element and a unique identifier;
the second message portion may include at least one of content data of the multimedia message and a unique identifier;
the multimedia message service control element and the media charger server element may be included in one server entity.

By virtue of the proposed solutions, the following advantages can be achieved, for example:
It is possible to transmit multimedia messages having a large size by using the MC server in the transmission to the receiver terminal. Thus, the load for multimedia message system as a whole and for the MMSC in particular can be reduced. This improves the performance of the system. When the download of the multimedia message or of the content thereof (second message portion) is controlled such that the transmission to the receiver terminal is executed during off-peak hours of traffic at the network, a faster download and an improved balancing in the network are achievable. Furthermore, an intelligent download management can be provided which allows to continue an interrupted download at the data part which was transmitted at last.
The proposed solution can be easily implemented in future and also existing systems. The media charger proxy functionality can be loaded to the respective elements, such as the terminal devices and the MC server, via a software upgrade. Also, already installed network elements, such as a conventional MC server, can be used for the further tasks defined by the present invention.

The above and still further objects, features and advantages of the invention will become more apparent upon referring to the description and the accompanying drawings.

### BRIEF DESCRIPTION OF THE DRAWINGS

FIG. 1 shows a block diagram illustrating a communication system in which a multimedia message is transmitted according to an embodiment of the present invention;

FIG. 2 shows a flow chart of a method for transmitting a multimedia message according to an embodiment of the present invention;

FIG. 3 shows a block circuit diagram illustrating a terminal device according to an embodiment of the present invention;

FIG. 4 shows a block circuit diagram illustrating a multimedia message service control element and a media charger server element according to an embodiment of the present invention;

FIG. 5 shows a signaling diagram illustrating a multimedia message transmission according to an embodiment of the present invention;

FIG. 6 shows a block diagram illustrating a communication system in which a multimedia message is transmitted, and a message flow according to a second embodiment of the present invention;

FIG. 7 shows a signaling diagram illustrating a multimedia message transmission according to a third embodiment of the present invention;

FIG. 8 shows a signaling diagram illustrating a multimedia message transmission according to a fourth embodiment of the present invention;

FIG. 9 shows a signaling diagram illustrating a multimedia message transmission according to a fifth embodiment of the present invention;

FIG. 10 shows a signaling diagram illustrating a multimedia message transmission according to a sixth embodiment of the present invention;

FIG. 11 shows a signaling diagram illustrating a multimedia message transmission according to a seventh embodiment of the present invention;

FIG. 12 shows a media charger server-client structure;

FIG. 13 shows a signaling diagram of a message flow in the media charger server-client structure according to FIG. 12;

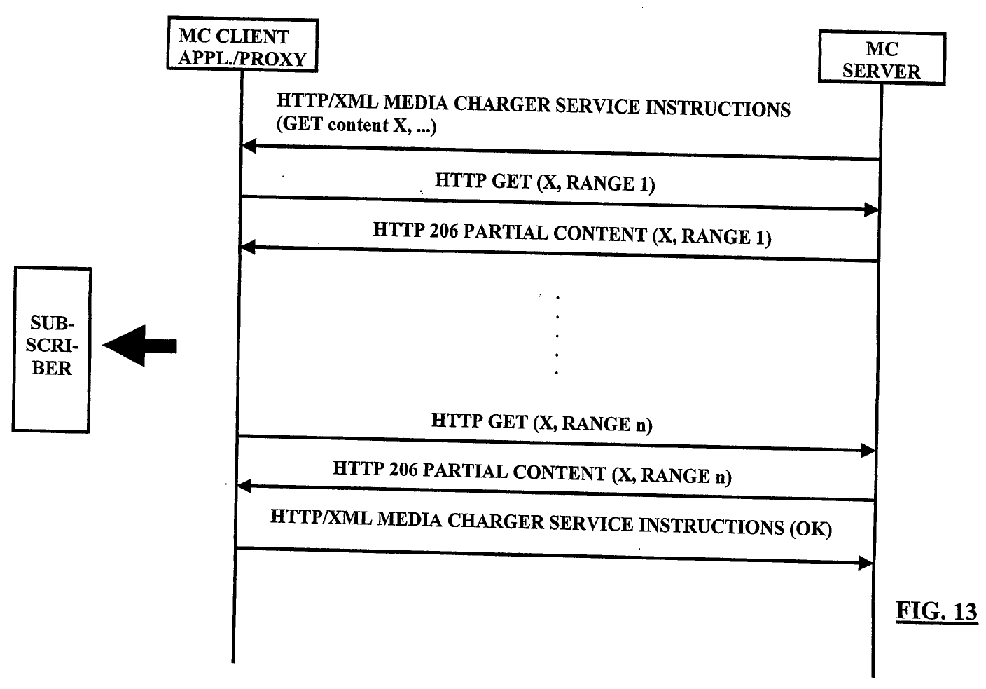

FIG. 14 shows a block diagram illustrating a communication system in which a multimedia message is transmitted conventionally;

FIG. 15 shows a signaling diagram illustrating a conventional multimedia message transmission in the communication system according to FIG. 14;

FIG. 16 shows a signaling diagram illustrating a multimedia message transmission according to a modified embodiment of the present invention; and

FIG. 17 shows a simplified illustration of an application example of the present invention.

### DESCRIPTION OF PREFERRED EMBODIMENTS

In the following, embodiments of the present invention are described with reference to the drawings.

The general idea of the present invention is to implement media charger system in an multimedia message system in order to allow a reliable and rigid delivery of large files attached, for example, on the MMS messages. For this purpose, a proxy, i.e. a so-called media charger MMS proxy application, is implemented in a terminal devices (and optionally in network elements). The media charger MMS proxy application is used to process messages, such as multimedia messages, by scanning them and by modifying them (i.e. the content or structure thereof) when the MMS message is transmitted and received. Thus, it is possible to separate and reroute content (i.e. attached files of the MMS message) to the media charger server, wherein at the receiving side the content is received and combined, for example, with user written message and the like. Preferably, a WAP GET operation is used for this purpose.

In other words, a media charger system is implemented between terminals and MMSC, and content transmission and recovery systems from the media charger system are implemented to a messaging system such as a MMS system. Preferably, the whole transmission process according to the present invention is transparent for a user, i.e. terminal users see the system as a normal MMS system.

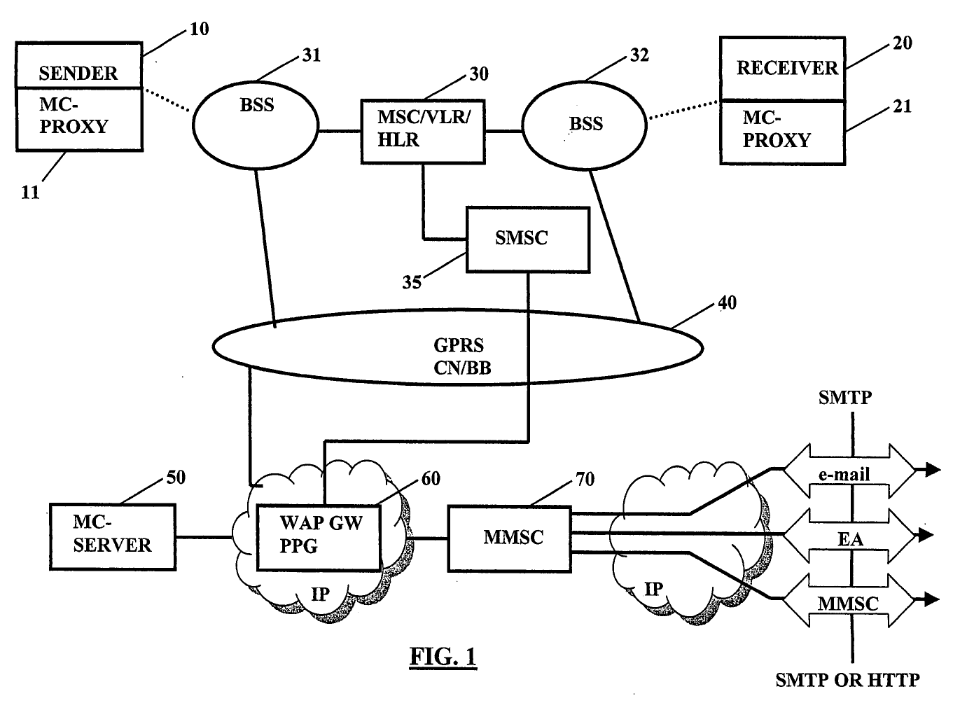

A first embodiment will be explained with reference to FIGS. 1 to 5.

Referring to FIG. 1, a simplified structure of a communication network, such as a GSM/GPRS or UMTS wireless network, is shown in which an embodiment of the present invention is applicable. It is to be noted that the communication network according to FIG. 1 represents only a simplified architecture of such a system in which the present invention is implemented. The network elements and/or their functions described herein may be implemented by software or by hardware. In any case, for executing their respective functions, correspondingly used devices or network elements comprise several means (not shown in FIG. 1) which are required for control, processing and communication functionality. Such means may comprise, for example, a processor unit for executing instructions and processing data, memory means for storing instructions and data, for serving as a work area of the processor and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), and interface means for establishing a communication connection under the control of the processor unit (e.g. wired and wireless interface means, an antenna, and the like). The respective interfaces and connection paths between the respective network elements and terminals depend on the used communication network type and are known to those skilled in the art. Thus, a detailed description thereof is omitted herein.

According to FIG. 1, the communication network comprises base station subsystems (BSS) 31 and 32 including, for example, a base station controller (not shown) and a base transceiver station (not shown). As an alternative, there may also be provided another type of access network subsystem, such as a radio access network or the like. The BSS 31, 32 are connected with a circuit switched core network 30 comprising a mobile switching centre (MSC), a visitor location register (VLR) and a home location register (HLR), for example. Furthermore, there is provided a packet switched core or backbone network (CN/BB) 40 based, for example, on GPRS to which the BSS 31, 32 are connected. The GPRS CN/BB 40 comprises several network elements (not shown), such as a SGSN, a GGSN and the like for controlling and relaying communications. A short message service center (SMSC) 35 as a control element for a short message service is also connected to the MSC/VLR/HLR 30. The SMSC 35 represents a type of a message transmission element in the communication network. Furthermore, a wireless application protocol (WAP) gateway or a push proxy gateway (PPG) 60 for relaying WAP signalling between network elements is provided in an IP environment. The WAP GW 50 represents another type of a message transmission element in the communication network. As mentioned above, WAP is a standard protocol for the presentation and delivery of wireless information and telephony services on mobile phones and other (wireless) terminals. Furthermore, a multimedia message service center (MMSC) 70 as a multimedia message service control element is provided which is connected with the WAP gateway 60. The MMSC 70 controls the transmission of multimedia messages in the communication network. In addition, the MMSC 1070 provides an application interface and a connection to other external applications (EA) or services, such a e-mail, the Internet, other MMSCs in different networks and the like, via a HTTP or SMTP interface.

Furthermore, a multimedia content control server/element which is referred to hereinafter as media charger (MC) server 50 as a media charger server element is provided. It is to be noted that the term “media charger” is used only as an explanatory expression and comprises all network elements or servers which may act as a multimedia content control server. The MC server 50 is connected with the network, for example, via the WAP gateway 60.

Terminal devices 10 and 20 located in the communication network act as a sender terminal 10, which transmits the multimedia message, and as a receiver terminal 20 to which the multimedia message is to be transmitted. Both terminal devices are provided respectively with a media charger multimedia message service (MC) proxy functionality or functional means 11, 21. The MC proxy functionality is used for processing the multimedia message at the sending side and for processing messages received at the receiving side, respectively.

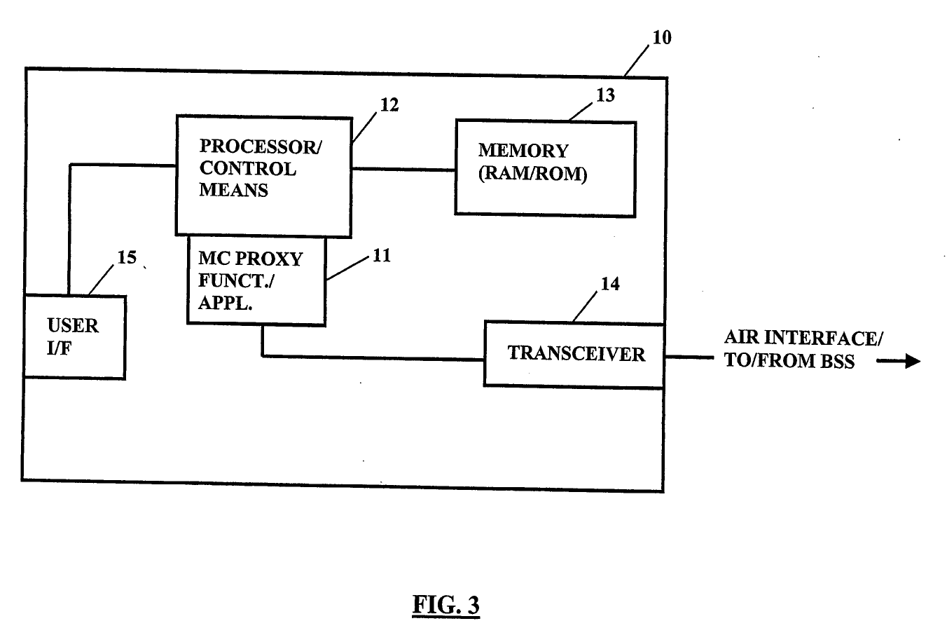

FIG. 3 shows a block circuit diagram illustrating the terminal device according to an embodiment of the present invention. It is to be noted that the general structure of the sender terminal device 10 and the receiver terminal device is similar. The differences in the processing executed in the respective terminal will be described below. However, it is preferable that each terminal device may act as both a receiver terminal device and a sender terminal device in the communication network.

In FIG. 3, as an example, the sender terminal device 10 is depicted. The terminal device 10 comprises, amongst other elements not shown, a processor or control means 12, such as a CPU or the like, which executes processing steps of the terminal device and controls the functions thereof. The processor 12 is connected with a memory which comprises, for example, a ROM and/or RAM. Furthermore, the processor 12 is provided with the MC proxy functionality 11, which is, for example, an application program or the like executed by the processor 12. A transceiver unit 14 for communicating with the network, e.g. through an air interface to the BSS 31, is connected to the processor 12, wherein the data received and transmitted by the transceiver element 14 are preferably send via the MC proxy functionality 11. Moreover, a user interface 15 comprising input means like keys, a display and the like is connected to the processor 12 for informing the user, inputting instructions of the user and displaying data to the user.

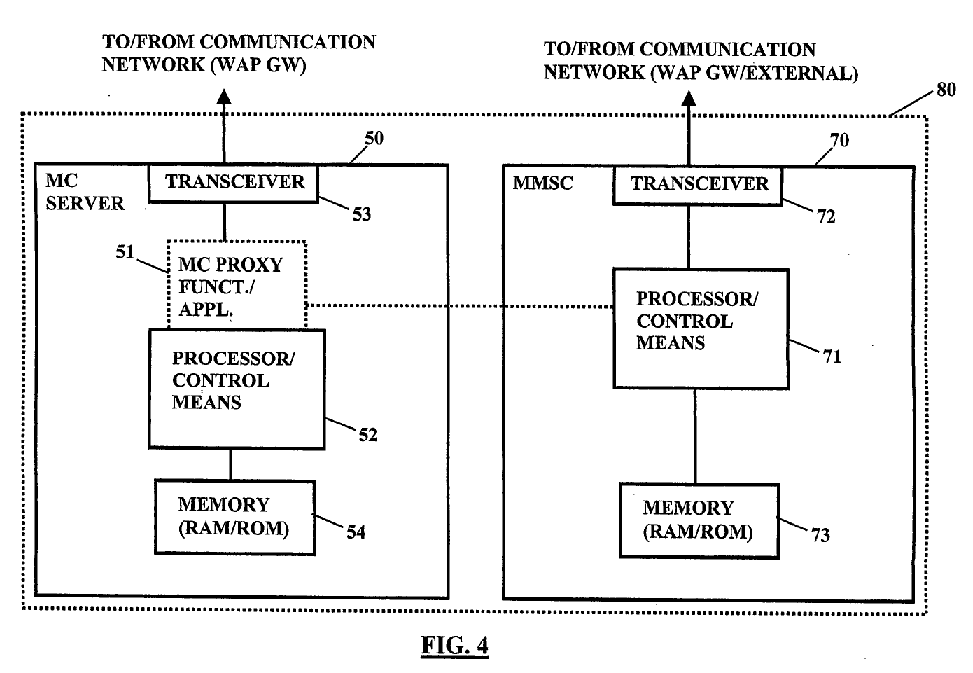

On the other hand, FIG. 4 shows a block circuit diagram illustrating details of the MMSC 70 and the MC server 50.

The MMSC 70 comprises a processor/control means 71, such as a CPU or the like, which is connected to a transceiver unit 72, such as a interface to an IP based network or the like. The transceiver unit 72 connects the MMSC 70 for example to the WAP gateway 60. Also other connections, such as to external networks, other MMSCs, an e-mail application and the like can be provided by the transceiver unit 72. Furthermore, a memory 73, such as a RAM, a ROM, a hard disk and the like is provided which is connected to the processor 71. The memory 73 stores control programs and the like, serves as a working area of the processor 71, is used for storing messages or message portions received via the transceiver 71, and the like.

The MC server 50 comprises a processor/control means 52, such as a CPU or the like, which is connected to a transceiver unit 53, such as a interface to an IP based network or the like. The transceiver unit 53 connects the MC server 50 for example to the WAP gateway 60. Furthermore, a memory 54, such as a RAM, a ROM, a hard disk and the like is provided which is connected to the processor 52. The memory 54 stores control programs and the like, serves as a working area of the processor 52, is used for storing messages or message portions received via the transceiver 53, and the like.

As an option, the processor 52 is provided with a MC proxy functionality or application 51. This will be described below in greater detail. The MC proxy functionality 51 may provide a connection to the MMSC 70, i.e. to the processor 71 thereof, in order to transmit instructions and data. The connection between the MC proxy functionality 51 and the processor 71 can be directly via a corresponding network part, e.g. an IP based network, or via the transceivers 53 and 72, i.e. via the WAP gateway 60.

Even though the MMSC 70 and the MC server 50 are shown in FIG. 1 as separate network elements, such as servers or the like, it is also possible that both elements 50 and 70 are combined in one server entity 80. Then the respective functions of the MC server 50 and the MMSC 70 are executed by the same processor, transceiver and memory of the server entity 80.

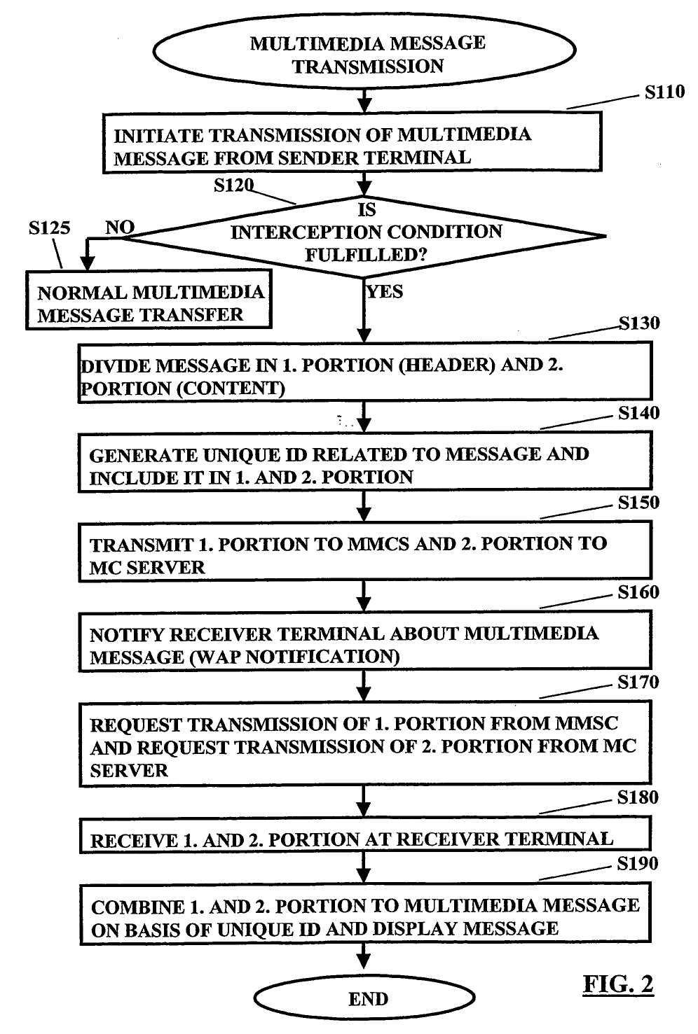

Referring to FIG. 2, a flow chart of a method for transmitting a multimedia message according to an embodiment of the present invention is shown. When a multimedia message is to be transmitted from the sender terminal device 10 to, for example, the receiver terminal device 20, in step 110, a transmission step is initiated and the message is checked. Then, in step S120, the MC proxy functionality 11 of the sender terminal device 10 checks whether an interception condition is fulfilled. This means that the MC proxy functionality 11 checks whether the multimedia message to be transmitted falls under a predetermined condition which causes that the multimedia message is processed by the MC proxy functionality 11. For example, the predetermined condition can be a threshold value for a size of the multimedia message as a whole, or for a size of the attachment such as a picture file or the like. As further predetermined conditions, for example, settings of a user or a system operator can be used, such as that the multimedia message is always (or never) to be processed by the MC proxy functionality 11, or when a predetermined destination is recognized, for example another mobile terminal, by means of the destination telephone number or the like, or when a predetermined transmission network is recognized, i.e. operator or service provider offering MMS transmission services as defined in the present invention. The latter condition may be provided, for example, by a corresponding signaling from the network.

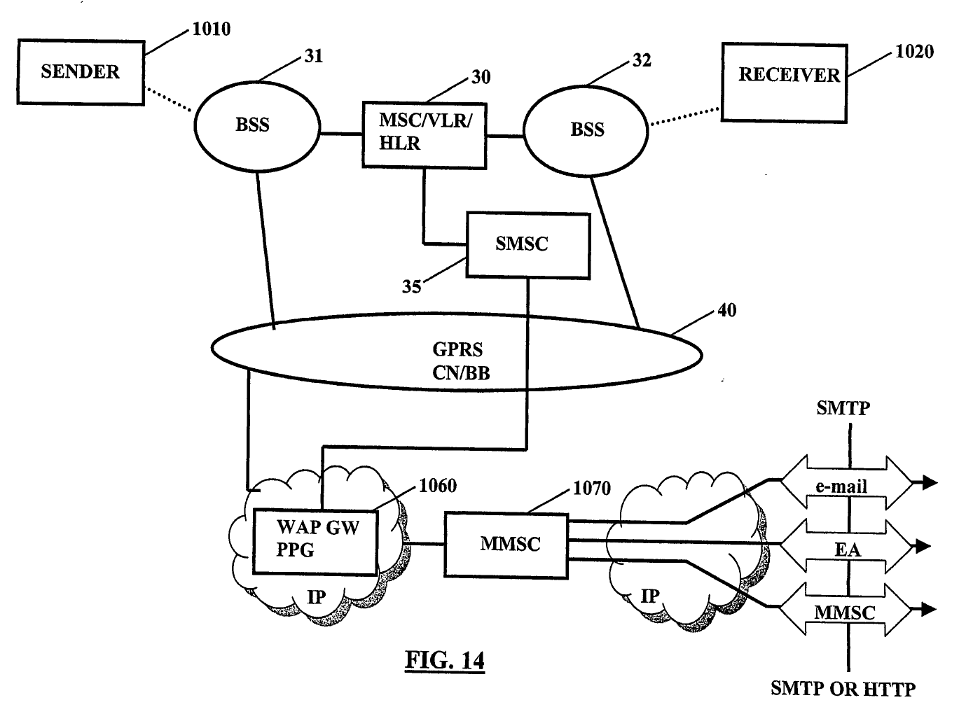

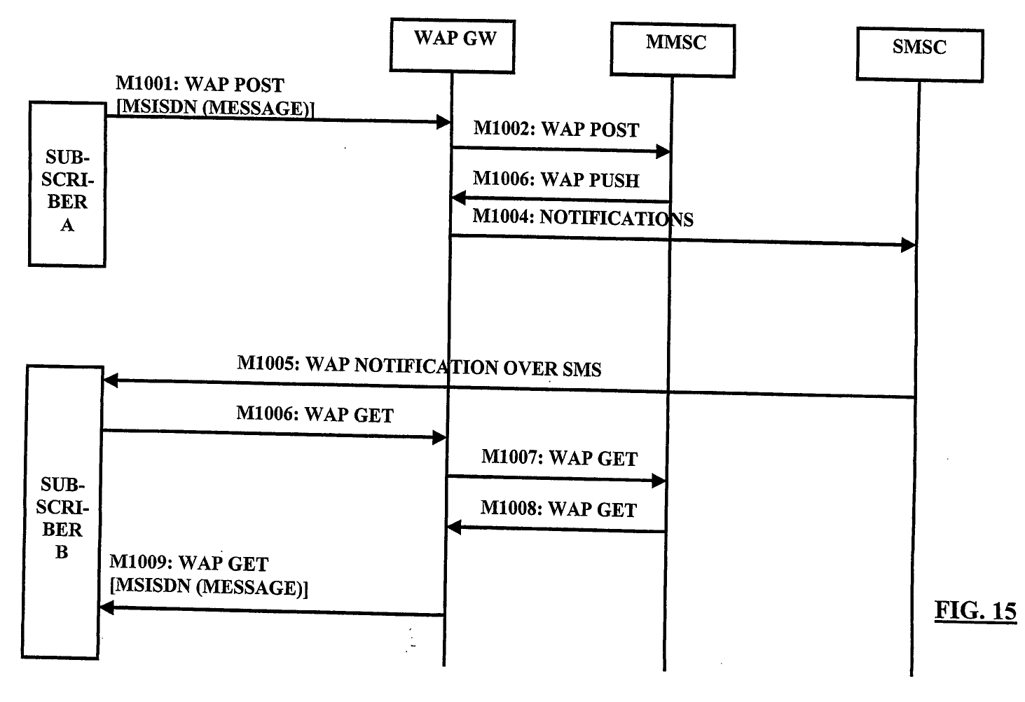

If it is decided in step S120 that the predetermined condition is not fulfilled, the multimedia message is not intercepted by the MC proxy functionality 11 and normally transferred (step S125), as shown for example in FIGS. 14 and 15.

On the other hand, if the decision in step S120 is YES, the multimedia message is intercepted and further processed by the MC proxy functionality 11 in step S130.

In step S130, the multimedia message is divided by the MC proxy functionality 11. This means that the MC proxy functionality 11 divides the message into a first message portion and a second message portion. The first message portion comprises, for example, a header indicating communication information which are obtained from the original multimedia message. The communication information may comprise at least one of a written message part, a media charger tag, a network address of the media charger server element, a unique ID (described later) and the like. The second message portion includes in particular the content data of the multimedia message, and/or in addition also text, e.g. a text message, and/or a unique ID (described later). It is to be noted that the MC proxy functionality 11 may divide the multimedia message into more than two message portions, in particular when the multimedia message includes more than one content file. The content data can be also divided in one or more parts, especially if the content data or file is large. However, the parts are handled further in the same way and like the single second message portion mentioned above. Furthermore, the MC proxy functionality 11 generates (step S140) a unique identification element (ID) which is attached to the multimedia message to be transmitted and thus to the first and second message portions. The unique ID is included in the first and the second (or more) message portions, respectively, for binding the content data and the header together.

After the processing of the MC proxy functionality 11 in step S130 is completed, the first message portion (i.e. the header) is transmitted (step S150) from the sender terminal device 10 (i.e. by the MC proxy functionality 11) to the MMSC 70. For example, the transmission can be effected by means of a WAP POST operation via BSS 31, the GPRS CN/BB 40 and the WAP gateway 60. On the other hand, the one (or more) of the second message portions is transmitted to the MC server 50, for example by means of a HTTP PUT operation via BSS 31, the GPRS CN/BB 40 and the WAP gateway 60. It is to be noted that both the first and the one or more of the second message portions include the unique ID.

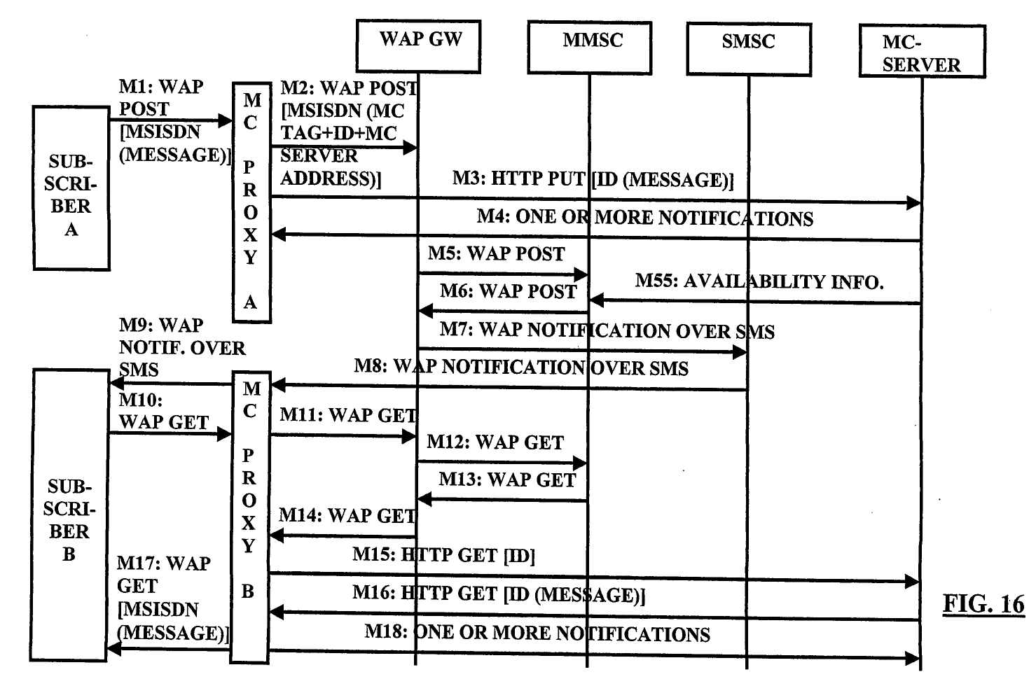

When the MMSC 70 receives the first message portion, it retrieves communication information to obtain the destination and transmits a notification to the destination (step S160), i.e. to the receiver terminal device 20, in order to notify the transmission of a multimedia message. The notification can be transmitted as a WAP notification over SMS to the receiver terminal device, for example, via the WAP gateway 60 to the SMSC 35, where a preset short message indicating the MMS receipt is prepared and sent to the terminal device 20 via the MSC 30 and the BSS 32. Alternatively, the MMSC 70 can also notify the receiver terminal device 20 by means of another signaling mechanism, such as an IP based signaling. As a further alternative, a notification to the destination (compare step S160), i.e. to the receiver terminal device 20 in order to notify the transmission of a multimedia message is transmitted after the MC server 50 has received the (one or more) second message portion. This will be further described below in connection with FIG. 16. When the receiver terminal device side receives the notification in the form of the WAP notification over SMS, it may inform the user and await further instructions. Alternatively, the further reaction of the receiver terminal device is automatically controlled, e.g. by means of preset instructions or the like. Like the sender terminal device 10, the receiver terminal device 20 comprises a MC proxy functionality 21 which is used for processing the incoming signalling, i.e. the notification from the MMSC 70. For example, the MC proxy functionality 21 recognizes that a processing of the announced multimedia message is necessary when the message or file size indicated in the notification exceeds the threshold value. Furthermore, the existence of the unique ID or of a special MC tag can be used as the indication for the need of processing by the MC proxy functionality 21. Also a user or network operator presetting for always (never) processing incoming messages by the MC proxy functionality 21 can be used.

In any case, if it is determined by the receiver terminal device side, e.g. by the MC proxy functionality 21, that the message is transmitted by the sender terminal device 10 by using the mechanism according to the present invention, a request for transmitting the first portion is sent, for example, by the MC proxy functionality 21 to the MMSC 70 (step S170). This request is for example a WAP GET request transmitted via the WAP gateway 60. Furthermore, a request for transmitting the second portion is sent, for example, by the MC proxy functionality 21 to the MC server 50. The second request is normally transmitted when the first portion is received at the MC proxy functionality 21 since from this portion the address of the MC server 50 is retrieved. The second request for transmitting the second message portion is transmitted by means of a HTTP GET request, for example, either directly to the MC server 50 through an IP network, or via the WAP gateway 60.

In step S180, both the first and the second message portion are received at the MC proxy functionality 21. Then the MC proxy functionality 21 is able to combine the first and the second portion by means of the unique ID in order to obtain the complete multimedia message comprising all the header information and content data (step S190), and the multimedia message can be displayed to the user.

It is to be noted that the MC server 50, after receiving the request from the MC proxy functionality 21, may postpone the transmission of the second message portion until an off-peak time, or the MC proxy functionality 21 sends the request for transmitting the first and/or the second message portion postponed. The postponement of the transmission of the multimedia message can also be initiated by the MC Proxy functionality 11 of the sender terminal equipment, based, for example, on settings for the terminal device 10. In addition, when the transmission of in particular the second message portion is interrupted, the transmission can be reassumed at the interruption position when the interruption cause is not present anymore.

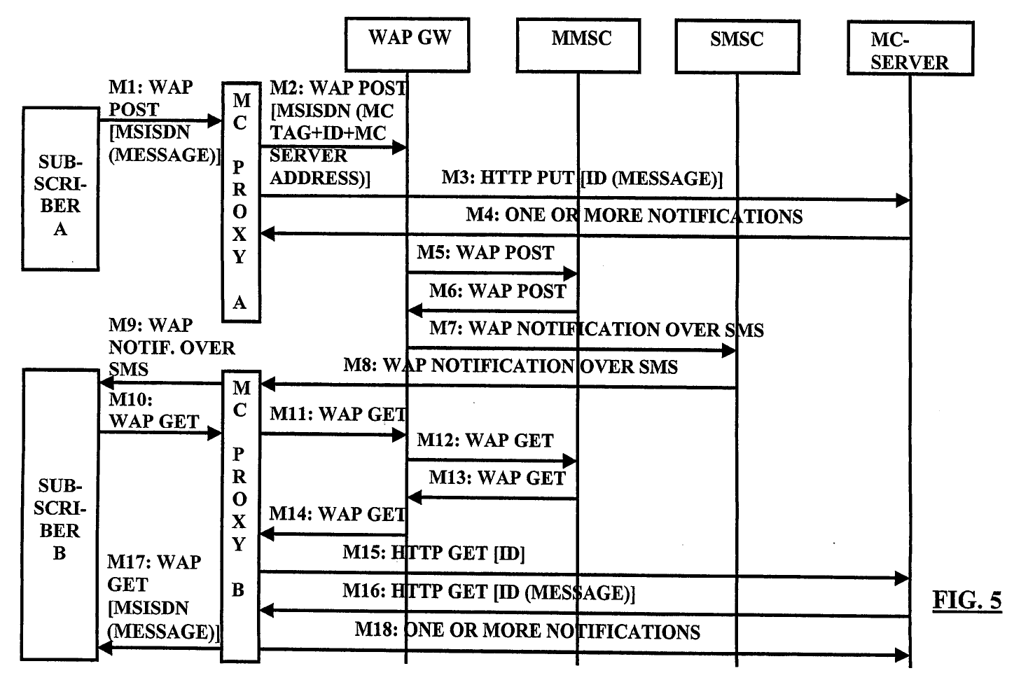

In FIG. 5, a signaling diagram is shown for illustrating the multimedia message transmission according to the present embodiment of the present invention.

First, when the transmission of the multimedia message is initiated by a WAP POST operation including the MSISDN and the message (message M1), the MC proxy functionality checks the message to be transmitted, as described above. For example, if the size of the MMS message is bigger than a threshold size, the message is divided to a content (second message portion), such as a file attachment, and to a header (first message portion), such as a message header (i.e. written message). Furthermore, unique message identifiers are created and added for the content and the header wherein that identifiers bind the content and header together. Then, the content with the identifiers is transmitted to the MC server by means of a HTTP PUT operation (message M3), while the header with the identifiers is transmitted by WAP POST operation via the WAP GW to the MMSC (messages M2 and M5). The MC server can send one or more notifications to the MC proxy functionality in order a acknowledge the receipt of the content, for example.

When the MMSC receives the message M5 (i.e. the header with the identifiers), it determines the destination (i.e. subscriber B), it transmits the notification with said message identifiers about the MMS message to a subscriber B terminal. This is performed by a WAP POST message to the WAP GW (message M6), which in turn transmits a message M7 indicating a WAP notification over SMS to the SMSC, and the SMSC sends a short message or the like including the WAP notification the MC proxy functionality of the receiver side (message M8).

When the MC proxy B receives the message M8, it informs the user via the terminal device about the WAP notification (message M9) and receives an instruction to retrieve the message by means of an WAP GET operation initiated by the subscriber B terminal (message M10). Then, the MC proxy B sends a request in form of the WAP GET request with the message identifiers via the WAP GW to the MMSC (messages M11 and M12) whereupon the MMSC transmits back the header the header of the MMS message including the message identifiers (messages M13, M14). Then, the MC proxy B sends a request to transmit the content to the MC server by means of a HTTP GET message including the message identifiers (message M15). The MC server transmits from the MC server the content of the MMS message including the message identifiers to the MC proxy B (message M16), and the MC proxy B confirms the (complete) receipt with message M18. Furthermore, after combining the header and the content, the WAP GET operation with the subscriber B terminal is completed by means of message M17 where the message is provided to the terminal.

In the following, a further modification of the first embodiment is described with reference to FIG. 16.

FIG. 16 shows a signaling diagram illustrating a multimedia message transmission according to a modified example of the preceding embodiment of the present invention.

The signaling diagram according to FIG. 16 is similar to that according to FIG. 5 wherein a new message M55 between messages M5 and M6 is added. The other messages as well as their processing and function are similar to those according to FIG. 5 so that only the differences and the facts resulting therefrom will be described in the following.

In the example according to FIG. 5, the notification about the message is sent immediately after the MMSC gets information about a transmitted MMS header information (messages M6 to M8 in FIG. 5). However, there may be also a case where this immediate transmission of the notification is not optimal. For example, when large contents are t be transmitted by means of the media charger system utilizing a principle of transmitting large contents during off-peak times, there might be a time gap between the notification and when the content is actually available at the MC server.

Therefore, a new message M55 is introduced in the system which informs the MMSC that the whole content is now received at the MC server and is available for download. This means that the MC charger is configured to recognize that the full content is received (by means of message path M3), and then to send the message M55 to the MMSC.

On the other hand, it is preferable that the MMSC is configured to await the message M55 from the MC server before the notification message flow (messages M6 to M8) is started. In other words, only after this message M55 is received by the MMSC, the notification signal M6 is sent to WAP GW which further initiates notification M8 as described above.

Additionally, the signal M55 may include information when the content at the MC server is available for an off-peak downloading. By means of such an information there are several options available for the further processing:

1) alternatively, the notification message flow (messages M6 to M8) is sent when the off-peak time begins
2) the notification message M8 to the MC proxy B (receiver terminal device or subscriber B) includes information about the off-peak time, that is presented to the user, so that user may wait for that specific time for downloading (i.e. message M10). Alternatively, the user may ignore this and initiate downloading immediately after receiving the notification M8. Furthermore, as another alternative, the MC proxy B may be configured to automatically initiate the downloading at off-peak time or immediately, depending on the settings in the MC proxy B (subscriber B).

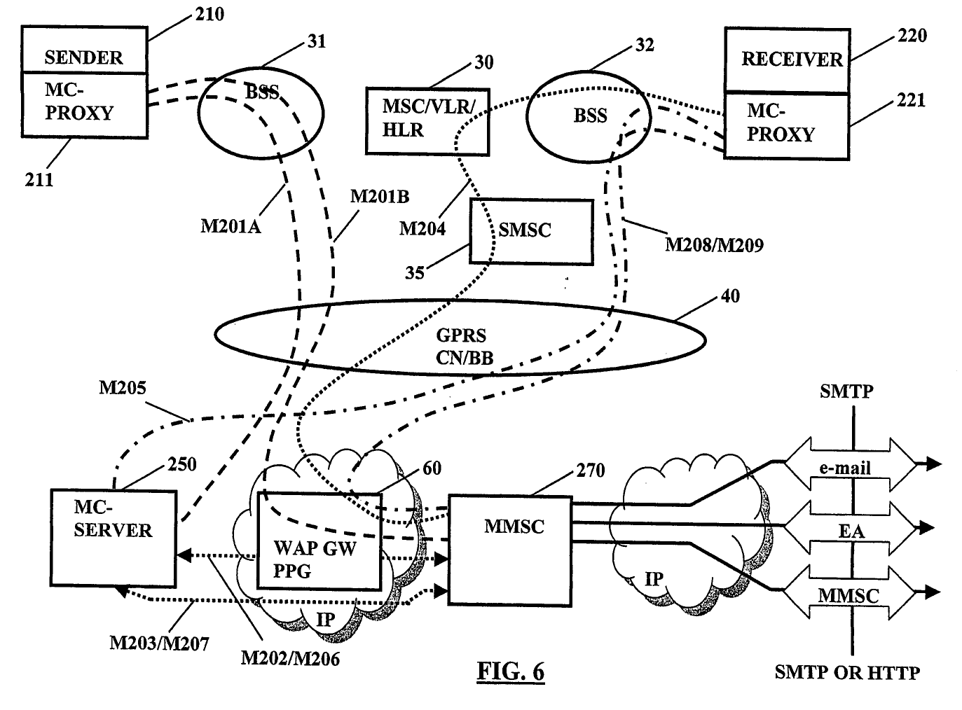

In FIG. 6, a block diagram illustrating a communication system in which a multimedia message is transmitted, and a message flow according to a second embodiment of the present invention is shown.

The general architecture of the communication system of the second embodiment is similar to that according to that of the first embodiment shown in FIG. 1. The main differences between the second embodiment and the first embodiment concern the processing and operations of the sender terminal device 210 in connection with the MC proxy functionality 211, the receiver terminal device in connection with the MC proxy functionality 221, the MC server 250 and the MMSC 270.

One major difference of the second embodiment to the first embodiment is that the MMS message is not divided by the MC proxy functionality 211 in the sender terminal device 210. This means that the content, such as a file attachment, of a message is also transmitted to the MMCS 270, whereas in the first embodiment the MMS message is divided to the header and the content and the content is only and directly transmitted to the MC server.

The transmission of a message from the sender terminal device 210 to the receiver terminal device 220 according to the second embodiment is described in the following.

When the transmission of the MMS message is initiated in the sender terminal device 210, the MC proxy functionality 211 checks whether the message is to be intercepted, i.e. whether the message is to be send in a normal way or by means of the operation involving the media charger system. The interception is executed, for example, in one of the following situations: always (e.g. according to a pre-setting by the user or the network operator); when the MMS is above a certain size threshold value (e.g. >500 kB); never (e.g. according to a pre-setting by the user or the network operator).

In case the MC proxy functionality 211 decides that there is no reason for an interception of the message, it is followed the normal MMS message transmission procedure (indicated by the message flow M201B).

On the other hand, when the message is to be intercepted and thus to be processed by means of the media charger portion of the network, MC proxy functionality 211 adds one or more tags or identifiers to one or more of the existing fields in the message. Then, the MC proxy functionality 211 sends/uploads the message (including the tags or identifiers) to the MC server 250 via the BSS 31, the GPRS CN/BB 40 (see message M201A). This sending/uploading can happen immediately or delayed (e.g. night time), depending on the settings.

Alternatively to the above, the MC proxy functionality 211 does not add one or more tags or identifiers but is only responsible for sending/uploading the message to the MC server 250. In this case, either the MC server 250 or the MMSC 270 creates and adds one or more tags or identifiers to one or more of the existing fields in the message when the message is received.

When MC server 250 receives the MMS message it forwards it to the MMSC 270. The MMSC 270 receives the MMS massage like any normal MMS message sent. The transmission from the MC server 250 to the MMSC 270 can be performed either through the WAP gateway 60 by means of a WAP POST operation (message M202), or directly to MMSC 60 by means of a HTTP POST operation (message M203).

The MMSC 270 processes the MMS message received from the MC server 250 in a normal way, i.e. the MMSC 270 sends out a notification message to the receiver terminal device 220, for example by means of a short message via the SMSC 35 (message M204).

When a terminal with MC proxy capabilities, i.e. the receiver terminal device 220 having the MC proxy functionality 221, receives a MMS notification, e.g. via the SMSC 35, the MC proxy functionality 221 intercepts it. The interception may be based on one of the following settings or situations: always (e.g. according to a pre-setting by the user or the network operator); when the MMS is above certain size threshold value (e.g. >500 kB); the MMS is “tagged” by the MC proxy functionality (i.e. MC tag or identifiers) in the sending end (MC proxy functionality 211); the MMS is ‘tagged’ by the MC server 250 or by the MMCS 270 (in case the MC proxy functionality 211 has not included such tags or identifiers); never (e.g. according to a pre-setting by the user or the network operator).

When the MC proxy functionality 221 intercepts the MMS message transmission, it sends, for example, a WAP GET message to the MC server 250 (message M205). Upon reception of the WAP GET message, the MC server requests the MMS message from MMSC 270, either via the WAP gateway 60 by using a WAP GET request (message M206) or directly from the MMSC 270 by using a HTTP GET request (message M207).

After receiving the MMS message at the MC server 250, the MMS message can be delivered to the terminal by means of media charger methods described above. Preferably, the MC proxy functionality 221 of the receiver terminal device 220 is configured to put the MMS message received from the MC server 250 to a correct folder for a “normal” MMS reception so that the user does not feel any differences to the normal MMS transmission.

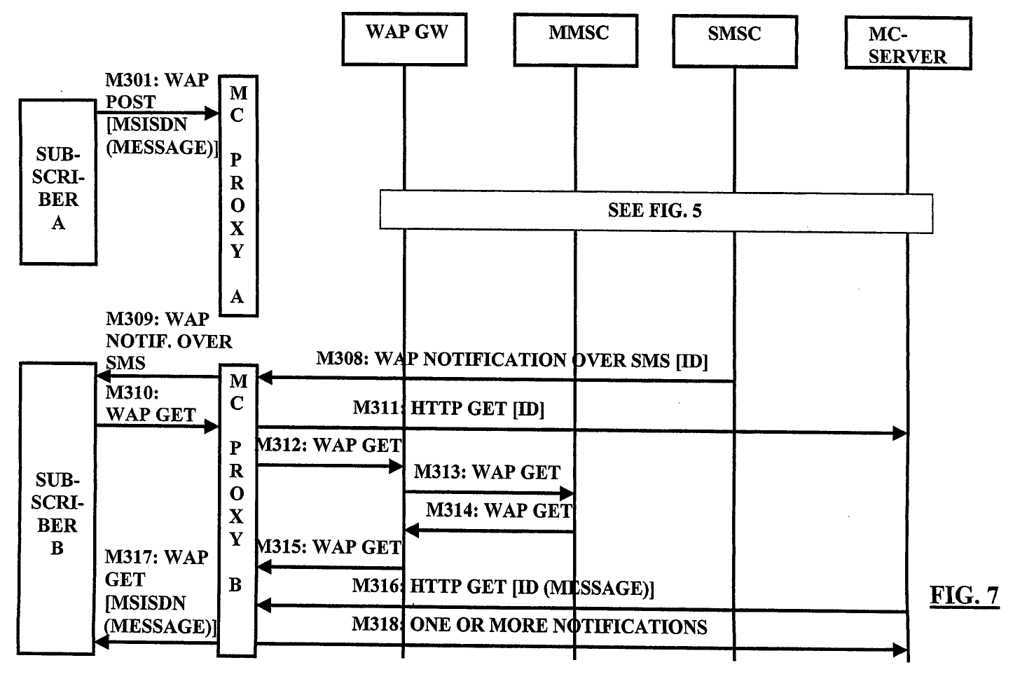

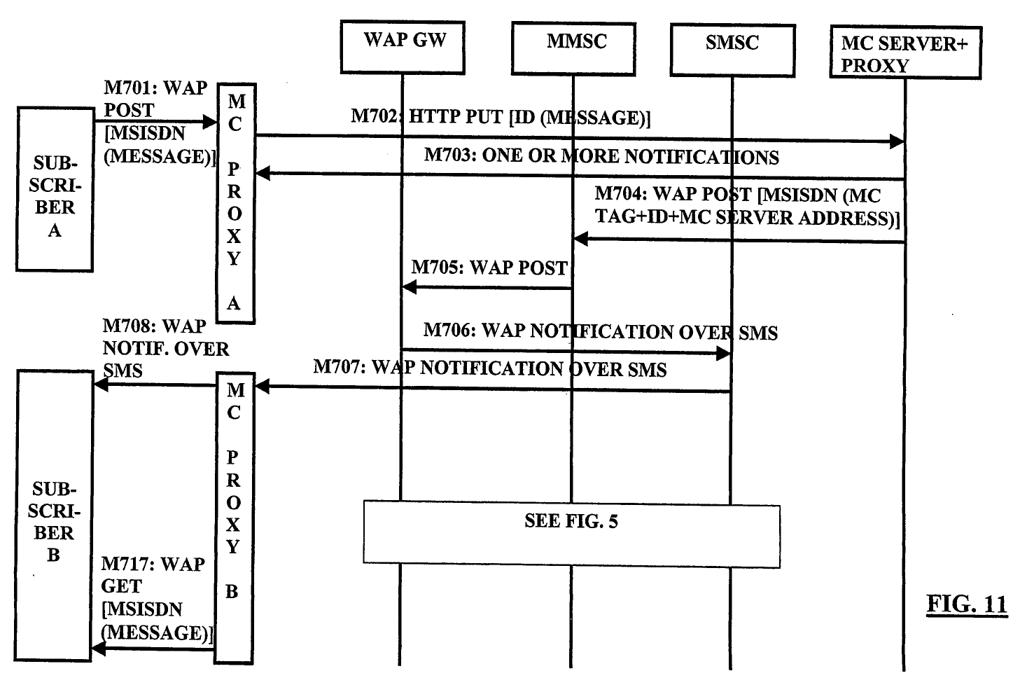

In the following, third to seventh embodiments according to the present invention are described in connection with signaling diagrams shown in FIGS. 7 to 11. The third to seventh embodiments are modifications of the first embodiment and applicable in the communication network according to FIG. 1 and the devices and elements according to FIGS. 3 and 4. The differences between the first embodiment and the third to seventh embodiments concern the processing and operation of at least one of the MC proxy functionalities of the sender or receiver terminal devices, the MC server and the MMSC. For the sake of simplicity, only those features being different to the foregoing embodiments are described in greater detail.

In FIG. 7 a signaling diagram illustrating a multimedia message transmission according to the third embodiment of the present invention is shown.

When the transmission of the message is initiated (message M301) at the sender terminal device (subscriber A), the following steps are equivalent to those described in FIG. 5 (messages M2 to M7) and thus not defined herein.

In message M308, the notification from the MMSC (WAP notification over SMS) is sent to the receiver terminal device (subscriber B), wherein the notification includes also information necessary for finding the MC server and for identifying the MMS message (i.e. in particular the second message portion).

When the MC proxy functionality B informs the user (message M309) and receives the instruction to get the MMS message (message M310, WAP GET), the MC proxy functionality B sends a HTTP GET message (message M311) directly to the MC server at the same time when the WAP GET request (messages M312 and M313) is sent to the MMSC. As mentioned above, in this case it is necessary that the WAP notification includes all the information needed for the direct HTTP GET. The MC proxy functionality B receives the first message portion (header, messages M314 and M315) via the WAP GET operation from the MMSC and the second message portion (content, message M316) via HTTP GET operation from the MC server similar to the first embodiment. The further processing of notifying the MC server (message M318) and combining and displaying the MMS message (message M317) are also similar to the first embodiment.

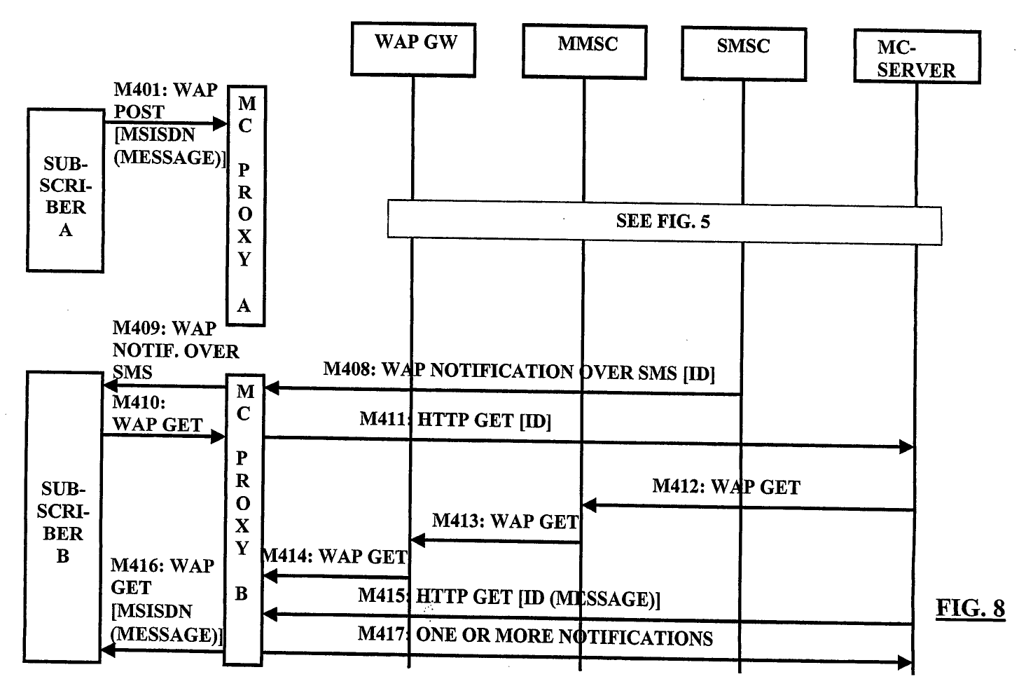

In FIG. 8 a signaling diagram illustrating a multimedia message transmission according to the forth embodiment of the present invention is shown.

When the transmission of the message is initiated (message M401) at the sender terminal device (subscriber A), the following steps are equivalent to those described in FIG. 5 (messages M2 to M7) and thus not defined herein.

In message M408, the notification from the MMSC (WAP notification over SMS) is sent to the receiver terminal device (subscriber B), wherein the notification includes also information necessary for finding the MC server, for identifying the MMS message (i.e. in particular the second message portion) and information about the MMSC (address information, identifier or the like).

When the MC proxy functionality B informs the user (message M409) and receives the instruction to get the MMS message (message M410, WAP GET), the MC proxy functionality B sends a HTTP GET message (message M411) directly to the MC server. As mentioned above, in this case it is necessary that the WAP notification includes all the information needed for the direct HTTP GET.

The MC server sends a WAP GET message to the MMSC (message M412) at the same time when transmitting HTTP GET to the MC proxy functionality B of the receiver terminal device (subscriber B) (message M415). Therefore, the MC server needs to know via which MMSC the MMS message is routed. This information is received by the HTTP GET message from the MC proxy functionality B, for example. The MMSC transmits the first message portion to the receiver terminal side (messages M413, M414) upon receipt of the WAP GET message from the MC server (message M412).

The MC proxy functionality B receives the first message portion (header, message M414) via the WAP GET operation from the MMSC and the second message portion (content, message M415) via HTTP GET operation from the MC server similar to the first embodiment. The further processing of notifying the MC server (message M417) and combining and displaying the MMS message (message M416) are also similar to the first embodiment.

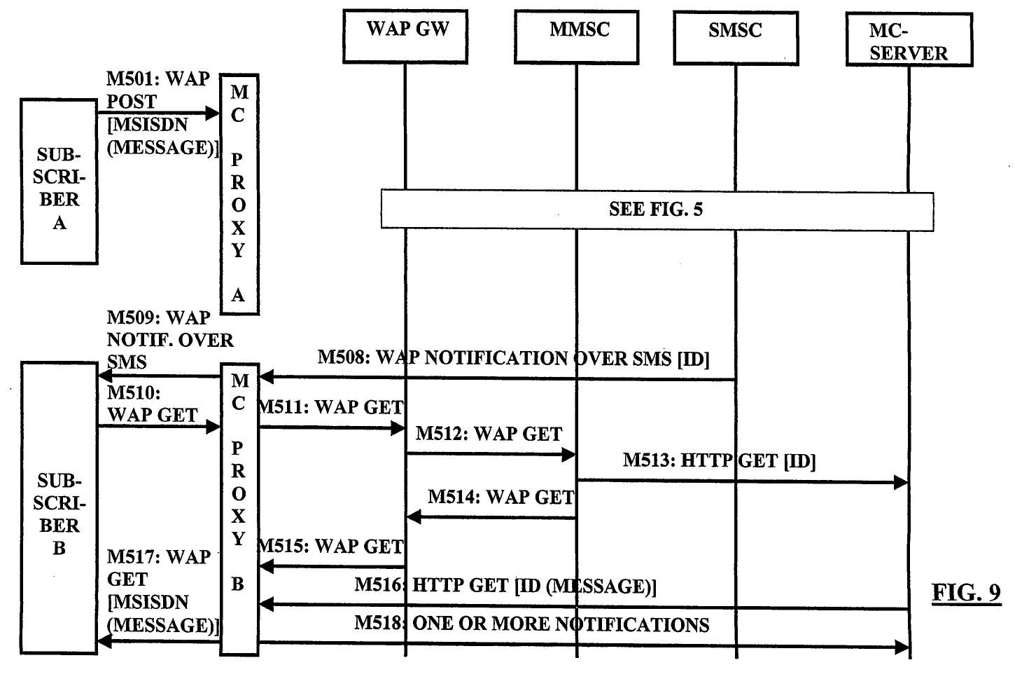

In FIG. 9 a signaling diagram illustrating a multimedia message transmission according to the fifth embodiment of the present invention is shown.

When the transmission of the message is initiated (message M501) at the sender terminal device (subscriber A), the following steps are equivalent to those described in FIG. 5 (messages M2 to M7) and thus not defined herein.

In message M508, the notification from the MMSC (WAP notification over SMS) is sent to the receiver terminal device (subscriber B), wherein the notification includes also information necessary for finding the MC server, and for identifying the MMS message (i.e. in particular the second message portion).

When the MC proxy functionality B informs the user (message M509) and receives the instruction to get the MMS message (message M510, WAP GET), the MC proxy functionality B sends a WAP GET request to the MMSC via the WAP GW (messages M511 and M512). When the MMSC receives the WAP GET message, it sends a HTTP GET message (message M513) to the MC server. Therefore, the MC server needs to know via which MMSC the MMS message is routed. This information is received by the WAP GET message from the MC proxy functionality B, for example.

The MC server sends a HTTP GET to the MC proxy functionality B of the receiver terminal device (subscriber B) (message M516) while the MMSC transmits the first message portion to the receiver terminal side (messages M514, M515) upon receipt of the WAP GET message from the MC proxy functionality.

The MC proxy functionality B receives the first message portion (header, message M515) via the WAP GET operation from the MMSC and the second message portion (content, message M516) via HTTP GET operation from the MC server similar to the first embodiment. The further processing of notifying the MC server (message M518) and combining and displaying the MMS message (message M517) are also similar to the first embodiment.

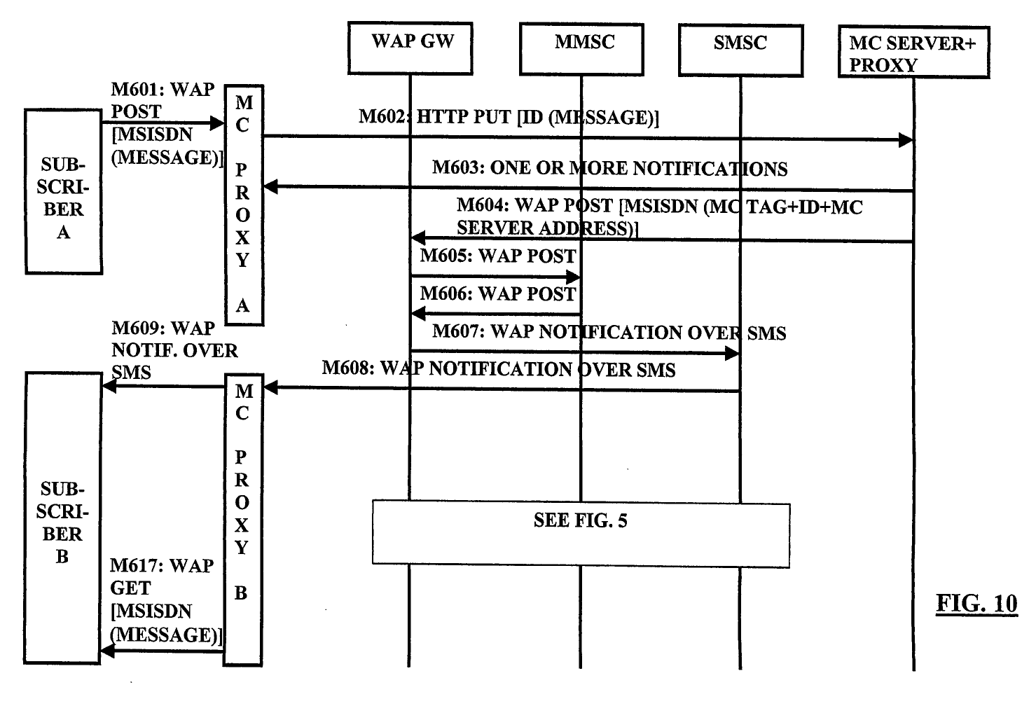

In FIG. 10 a signaling diagram illustrating a multimedia message transmission according to the sixth embodiment of the present invention is shown.

When the transmission of the message is initiated (message M601) at the sender terminal device (subscriber A), the MC proxy functionality A in the sender terminal device sends the HTTP PUT directly to the MC server (message M602). The MC server sends, when the HTTP PUT message is received, one or more notifications to the MC proxy functionality A for acknowledgement and the like, and transmits the first message portion (header, unique ID and the like) by means of a WAP POST operation to the WAP gateway (message M604). For this purpose, the MC server is provided with a own MC proxy functionality, which is shown in FIG. 4 at reference sign 51, for example.

From the WAP GW, the WAP POST, i.e. the second message portion, is forwarded to the MMSC (message M605) which then performs the steps defined in the first embodiment for notifying the receiver terminal device side about the message (messages M606 to M608).

The following steps may be equivalent to those described in FIG. 5 (messages M9 to M18) and thus not defined herein.

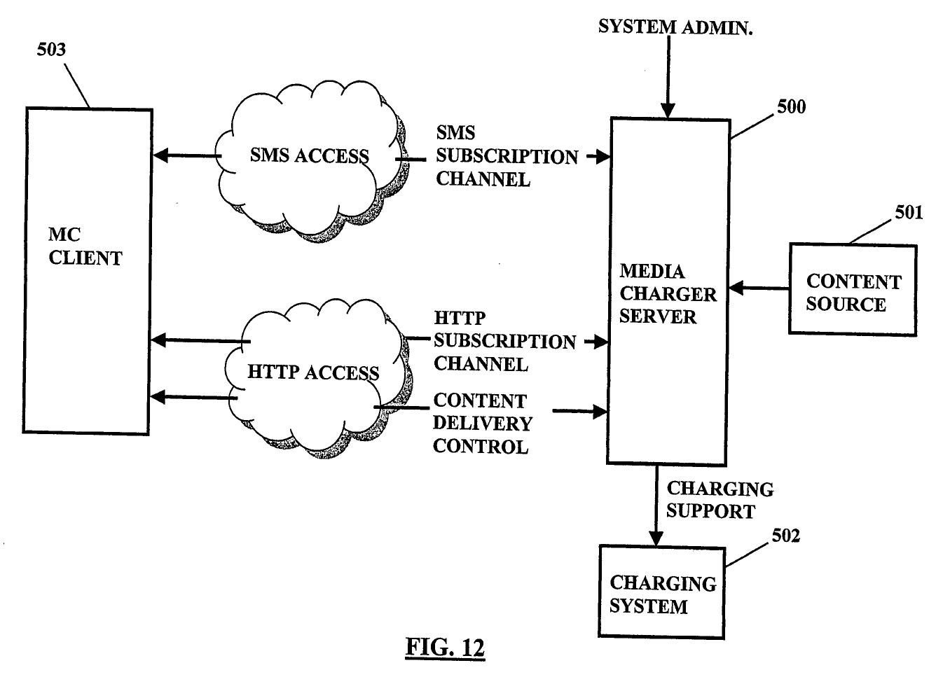

In FIG. 12 a signaling diagram illustrating a multimedia message transmission according to the seventh embodiment of the present invention is shown.

When the transmission of the message is initiated (message M701) at the sender terminal device (subscriber A), the MC proxy functionality A in the sender terminal device sends the HTTP PUT directly to the MC server (message M702). The MC server sends, when the HTTP PUT message is received, one or more notifications to the MC proxy functionality A for acknowledgement and the like, and transmits the first message portion (header, unique ID and the like) by means of a WAP POST operation to the MMSC (message M704). For this purpose, the MC server is provided with a own MC proxy functionality, which is shown in FIG. 4 at reference sign 51, for example.

The MMSC sends the WAP POST to the WAP gateway (message M705) which then further performs the steps defined in the first embodiment for notifying the receiver terminal device side about the message (messages M706 and M707).

The following steps may be equivalent to those described in FIG. 5 (messages M9 to M18) and thus not defined herein.

It is to be noted that the embodiments described above can also be combined. In particular the measures defined by the first embodiment or the modified example of the first embodiment and the third to seventh embodiments can be suitably combined as it is apparent to those skilled in the art.

Additionally, also the measured defined in connection with the second embodiment can be suitably combined with those of the other embodiments. As a corresponding explanatory example, in the following, a case is described on the basis of FIG. 6 where the basic multimedia message transmission procedure according to the first embodiment is used.

As mentioned above, in FIG. 6, a block diagram illustrating a communication system in which a multimedia message is transmitted, and a message flow according to another embodiment of the present invention is shown.

The general architecture of the communication system of the this embodiment is similar to that according to that of the first embodiment shown in FIG. 1. The main differences between the second embodiment and the first embodiment concern the processing and operations of the sender terminal device 210 in connection with the MC proxy functionality 211, the receiver terminal device in connection with the MC proxy functionality 221, the MC server 250 and the MMSC 270.

One major difference of the this embodiment, that relates to the first embodiment, to the second embodiment to which FIG. 6 is related is that the MMS message is divided by the MC proxy functionality 211 in the sender terminal device 210. This means that the content, such as a file attachment, of a message is not transmitted to the MMCS 270, unlike to the second embodiment, i.e. the MMS message is divided to the header and the content and the content is only and directly transmitted to the MC server.

When the transmission of the MMS message is initiated in the sender terminal device 210, the MC proxy functionality 211 checks whether the message is to be intercepted, i.e. whether the message is to be send in a normal way or by means of the operation involving the media charger system. The interception is executed, for example, in one of the following situations: always (e.g. according to a pre-setting by the user or the network operator); when the MMS is above a certain size threshold value (e.g. >500 kB); never (e.g. according to a pre-setting by the user or the network operator).

In case the MC proxy functionality 211 decides that there is no reason for an interception of the message, it is followed the normal MMS message transmission procedure (indicated by the message flow M201B).

On the other hand, when the message is to be intercepted and thus to be processed by means of the media charger portion of the network, MC proxy functionality 211 divide the MS message to the header part and one or more content parts and adds one or more tags or identifiers to one or more of the parts in the message. Then, the MC proxy functionality 211 sends/uploads the header part (including the tags or identifiers) to the MMSC server 270 via the BSS 31, the GPRS CN/BB 40 (see also message M201B). Then, the MC proxy functionality 211 sends/uploads the content (including the tags or identifiers) to the MC server 250 via the BSS 31, the GPRS CN/BB 40 (see message M201A). This sending/uploading can happen immediately or delayed (e.g. night time), depending on the settings.

Alternatively to the above, the MC proxy functionality 211 does not add one or more tags or identifiers but is only responsible for sending/uploading the message to the MC server 250. In this case, either the MC server 250 or the MMSC 270 or both creates and adds one or more tags or identifiers to one or more of the existing parts in the message when the message is received.

The MMSC 270 processes the MMS message header part received from the MC proxy 211 in a normal way, i.e. the MMSC 270 sends out a notification message to the receiver terminal device 220, for example by means of a short message via the SMSC 35 (message M204).

When a terminal with MC proxy capabilities, i.e. the receiver terminal device 220 having the MC proxy functionality 221, receives a MMS notification, e.g. via the SMSC 35, the MC proxy functionality 221 intercepts it. The interception may be based on one of the following settings or situations: always (e.g. according to a pre-setting by the user or the network operator); when the MMS is above certain size threshold value (e.g. >500 kB); the MMS is “tagged” by the MC proxy functionality (i.e. MC tag or identifiers) in the sending end (MC proxy functionality 211); the MMS is ‘tagged’ by the MC server 250 and/or by the MMCS 270 (in case the MC proxy functionality 211 has not included such tags or identifiers); never (e.g. according to a pre-setting by the user or the network operator).

When the MC proxy functionality 221 intercepts the MMS message transmission, it sends, for example, a WAP GET message to the MMSC server 270 (message M208). Upon reception of the WAP GET message, the MMSC server 270 transmits the MMS message header part to the MC proxy functionality 221, via the WAP gateway 60 by using a WAP GET request (message M209).

After receiving the MMS message header part the MC proxy 211 may request the MMS message content from MC server 250 by using HTTP GET via link M205. This is similar to that described in the second embodiment, for example, so that a further detailed description thereof is omitted here.

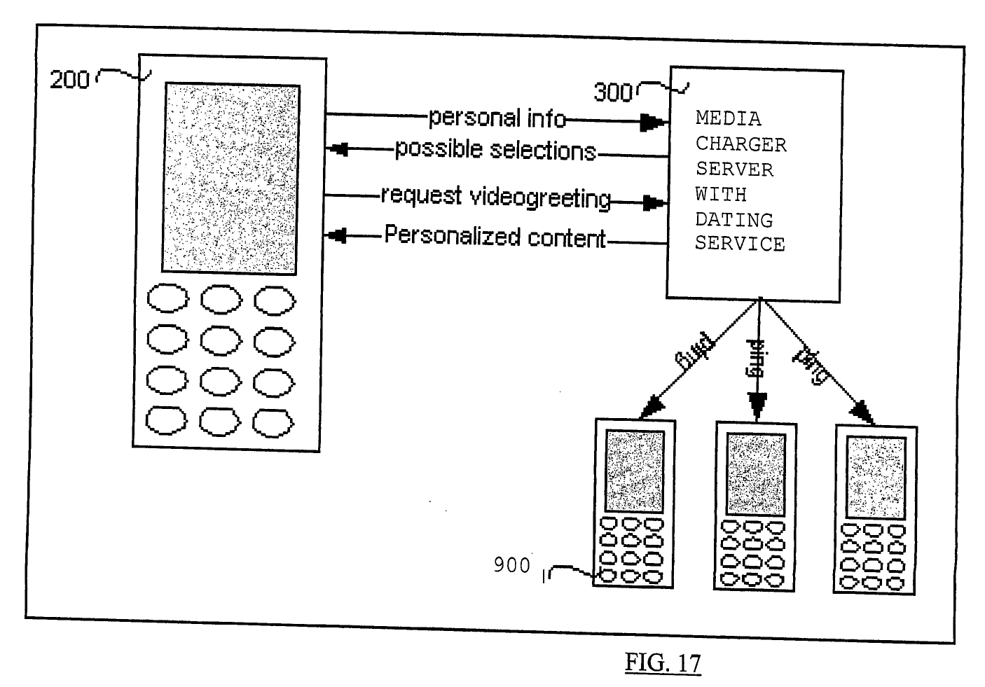

In FIG. 17, a simplified illustration of a communication network portion is shown by means of which another embodiment, which represents some sort of an application example of the present invention as an use case is described.

In FIG. 17, reference sign 200 denotes a sender terminal device, which may be similar to the sender terminal device 10 according to FIG. 1. Reference sign 900 denotes one or more receiver terminal devices which may be similar to the receiver terminal device 20 according to FIG. 1. Reference sign 300 denotes a media charger server. The media charger server 300 may have the same functionality like those of the preceding embodiments and includes further a dating service application.

It is to be noted that even though not shown in FIG. 17, additional network elements are to be provided in the communication network in order to be able to perform the message transmission as described below. These network elements include, for example, all additional network elements, servers, communication links and the like as shown and described in FIG. 1.

In the present embodiment, the general idea is to make message exchange to be more comfortable, for example dating to be more comfortable, and to increase the information received from the respective opponent. This is achieved by allowing both sides to create personal information and personal media files, where are both own features as well as what kind of features a party is looking for from the possible opponent. When additional information is set there, it is possible to get solutions, which are matching (matching can be presented, for example, as procent figures).

A possible use of a media charger system is to use a Dating solution to record videogreetings etc. and to send those to the server. Then, it is possible to “subscribe” the persons information as a channel or sub-channel and every time there will be more content, then automatically this information is sent to the terminal device.

By using the measures defined in the present invention, it is possible that during the registration process, a personal ID is available. So, the greetings can be set to be visible to a) all subscribers (terminal devices 200 and 900), b) set of subscribers based on ID (e.g. only left and right terminal device 900) or c) just one dedicated subscriber (e.g. only leftmost terminal device 900). This means that in the messaging network, there are a plurality of generic and personal introductions and greetings.

The concept of the present embodiment is to use the media charger server 300 as a two direction communication channel with grant/deny permission basis. Furthermore, the media charger server 300 is used to handle automatically the distribution list, for example after subscription or inventing based on handling (both user or host can start the discussion/communication chain). At the same time, the whole system can be managed, measured, handled with secure manners and be extreme personal to create highest possible user experience without loosing anything from usability. In addition, a manual acceptance or auto acceptance can be used, for example, based on a set of rules to decide who can subscribe the personal videogreetings. Thus, it is possible to make the system more “personal”, while additionally a more flexible and more usable massaging performance than in a conventional MMS-service providing a real communication solution for two- or multidirectional communication.

The personal information and personal media files may be transmitted preferably as MMS messages via MMS and media charger systems. This means, that transmitting and also receiving devices requires special media charger proxy functionalities, like those described above. If the personal media files (content part) are large (larger than, for example, a predetermined threshold value), they may be routed via the media charger system, while a header part of the MMS message is routed via the MMS system (MMSC).

There are several benefits, which are affecting the whole system. First, the whole system can be managed, measured, handled with secure manners and be extreme personal to create highest possible user experience without loosing anything from usability, at the same time. Furthermore, it is possible to use a manual acceptance or an automatic acceptance based on a set of rules to decide who can subscribe the personal videogreetings. The system is more personal, for flexible and more usable than a conventional MMS-service providing real communication solution for two- or multidirectional communication. From the other systems, who would the host know, it is possible to receive information about how many other subscribers/terminals has check his/her greeting or announcement. It is to be noted that the system according to this embodiment is able to get information in real-time.

It is to be noted that, even though the foregoing embodiments are mainly directed to the transmission of a multimedia message, the measures defined in the present invention are also applicable to other types of messages to be transmitted via a communication network, in particular to those messages having a larger file attachment or a large size. The actual size of the message or attachment for which the present invention is preferably to be executed may vary, for example, in dependence of the communication network concerned. Furthermore, the described network elements, such as the MC server or the MMSC, may be different to those used in another application of the present invention as long as the basic functions like message forwarding and processing are similar.

Moreover, it is obvious that the transmission paths defined in the preceding embodiments, such as the WAP, SMS, HTTP or IP based transmission paths, can be replaced by other present or future types of transmission paths.

It is to be further noted that the measures defined in the preceding embodiments are implementable by means of a computer program product, such as a software program or the like, which can be directly loaded into the internal memory of a computer which in turn executes the processing steps and functions defined above. Thus, the computer program product causes the computer or parts of the computer to act, for example, as the MMSC, the MC server, the terminal device, the MC proxy functionality and the like described above. Furthermore, the computer program product may comprise a computer-readable medium on which corresponding software code portions are stored.

As described above there are provided a method and system for transmitting a multimedia message, wherein a multimedia message to be transmitted is processed by dividing the multimedia message into at least a first message portion and a second message portion. The first message portion is transmitted to a multimedia message service control element, and the second message portion is transmitted to a media charger server element. A receiver terminal is notified about the transmission of the multimedia message The transmission of the first message portion from the multimedia message service control element to the receiver terminal is requested, and the transmission of the second message portion from the media charger server element to the receiver terminal is requested. At the receiver terminal the first message portion and the second message portion are combined for obtaining the multimedia message transmitted.

It should be understood that the above description and accompanying figures are merely intended to illustrate the present invention by way of example only. The preferred embodiments of the present invention may thus vary within the scope of the attached claims.

1-149. (canceled)

150. A method of transmitting a multimedia message, comprising processing a multimedia message to be transmitted by
dividing the multimedia message into at least a first message portion and a second message portion,
transmitting the first message portion to a multimedia message service control element,
transmitting the second message portion to a media charger server element,
notifying a receiver terminal about the transmission of the multimedia message,
requesting the transmission of the first message portion from the multimedia message service control element to the receiver terminal and
requesting the transmission of the second message portion from the media charger server element to the receiver terminal.

151. The method according to claim 150, wherein the processing of the multimedia message further comprises generating a unique identifier for the multimedia message and providing each of the first and second message portions with the unique identifier.

152. The method according to claim 150, wherein the notifying of the receiver terminal is executed when the first message portion is received by the multimedia message service control element.

153. The method according to claim 150, wherein the notifying of the receiver terminal is executed when the second message portion is received by the media charger server element.

154. The method according to claim 150, further comprising
receiving at the receiver terminal the first message portion before the requesting of the second message portion, and
combining the first message portion and the second message portion for obtaining the multimedia message transmitted.

155. The method according to claim 154, wherein the combining of the first message portion and the second message portion is executed by a media charger proxy functionality included in the receiver terminal.

156. The method according to claim 150, wherein the requesting of the transmission of the first and the second message portions are executed by a media charger proxy functionality included in the receiver terminal.

157. The method according to claim 150, wherein the processing further comprises
checking whether a predetermined condition is fulfilled for the multimedia message to be transmitted,
wherein the dividing of the multimedia message is inhibited when the predetermined condition is not fulfilled.

158. The method according to claim 150, wherein the processing is executed by a media charger proxy functionality in a sender terminal.

159. The method according to claim 150, wherein the first message portion includes a header indicating communication information, obtained from the multimedia message, comprising at least one of a written message part, a media charger tag, a network address of the media charger server element, and a unique identifier.

160. The method according to claim 150, wherein the second message portion includes at least one of content data of the multimedia message and a unique identifier.

161. The method according to claim 150, wherein at least one of transmitting of the first message portion, transmitting of the second message portion and notifying of the receiver terminal is effected at least in part by using an IP based communication path.

162. The method according to claim 150, wherein the transmitting of the first message portion and the second message portion are based at least in part on a transmission path including a wireless application protocol.

163. The method according to claim 150, wherein the notifying of the receiver terminal includes at least in part a transmission via a transmission path including a short message service signaling.

164. The method according to claim 150, wherein the multimedia message service control element and the media charger server element are included in one server entity.

165. The method according to claim 150, wherein the notifying of the receiver terminal comprises a transmission of a unique identifier and/or a network address of the media charger server element to a media charger proxy functionality in the receiver terminal.

166. The method according to claim 165, wherein the requesting of the first message portion and the requesting of the second message portion are executed simultaneously.

167. The method according to claim 165, wherein the requesting of the second message portion is executed prior to the requesting of the first message portion, wherein the requesting of the first message portion is executed by the media charger server element after receiving an information on the multimedia message service control element with the request for the second message portion from the receiver terminal.

168. The method according to claim 150, wherein the requesting of the second message portion is executed by the multimedia message service control element after receiving the request for the first message portion from the receiver terminal.

169. The method according to claim 150, further comprising transmitting the first message portion together with the second message portion to the media charger server element, wherein the transmitting of the first message portion to the multimedia message server control element is executed by the media charger server element.

170. The method according to claim 169, wherein the media charger server element comprises a media charger proxy functionality.

171. A method of transmitting a multimedia message, comprising
processing a multimedia message to be transmitted,
generating and providing a unique identifier for the multimedia message,
transmitting the multimedia message to a media charger server element,
transmitting the multimedia message to a multimedia message service control element,
notifying a receiver terminal about the transmission of the multimedia message when the multimedia message is received by the multimedia message service control element,
requesting the transmission of the multimedia message from the media charger server element to the receiver terminal
obtaining the multimedia message from the multimedia message service control element at the media charger server element, and
transmitting the multimedia message from the media charger server element to the receiver terminal.

172. The method according to claim 171, wherein the processing further comprises
checking whether a predetermined condition is fulfilled for the multimedia message to be transmitted,
wherein the transmitting the multimedia message to the media charger server element and generating and providing the unique identifier are inhibited when the predetermined condition is not fulfilled.

173. The method according to claim 171, wherein the generating and providing the unique identifier for the multimedia message is executed by one of a media charger proxy functionality of a sender terminal, the media charger server element and the multimedia message service control element.

174. A terminal device configured to send a multimedia message in a communication system, comprising:
a media charger proxy functional means which is configured to process the multimedia message to be transmitted by
dividing the multimedia message into at least a first message portion and a second message portion,
to transmit the first message portion to a multimedia message service control element, and
to transmit the second message portion to a media charger server element.

175. The terminal device according to claim 174, wherein the media charger proxy functionality is further configured to process the multimedia message by generating a unique identifier for the multimedia message and providing each of the first and second message portions with the unique identifier.

176. The terminal device according to claim 174, wherein
the media charger proxy functional means of the terminal is further configured to
check whether a predetermined condition is fulfilled for the multimedia message to be transmitted,
wherein the division of the multimedia message is inhibited when the predetermined condition is not fulfilled.

177. The terminal device according to claim 174, wherein the predetermined condition comprises a predefined threshold for a size of the multimedia message.

178. The terminal device according to claim 174, wherein the first message portion includes a header indicating communication information, obtained from the multimedia message, comprising at least one of a written message part, a media charger tag, a network address of the media charger server element, and a unique identifier.

179. The terminal device according to claim 174, wherein the second message portion includes at least one of content data of the multimedia message and a unique identifier.

180. The terminal device according to claim 174, wherein the terminal is configured to transmit, at least in part, at least one of the first message portion and the second message portion via an IP based communication path.

181. The terminal device according to claim 174, wherein the terminal is configured to transmit at least one of the first message portion and the second message portion at least in part via a transmission path including a wireless application protocol.

182. A method for transmitting a multimedia message from a terminal device in a communication system, comprising
processing the multimedia message to be transmitted by
dividing the multimedia message into at least a first message portion and a second message portion,
transmitting the first message portion to a multimedia message service control element, and
transmitting the second message portion to a media charger server element.

183. The method according to claim 182, wherein the processing of the multimedia message further comprises generating a unique identifier for the multimedia message and providing each of the first and second message portions with the unique identifier.

184. The method according to claim 182, wherein the processing of the multimedia message and the transmitting of the first message portion and the second message portion are executed by a media charger proxy functionality.

185. The method according to claim 182,
further comprising
checking whether a predetermined condition is fulfilled for the multimedia message to be transmitted,
wherein the dividing of the multimedia message is inhibited when the predetermined condition is not fulfilled.

186. The method according to claim 182, wherein the predetermined condition comprises a predefined threshold for a size of the multimedia message.

187. The method according to claim 182, wherein the first message portion includes a header indicating communication information, obtained from the multimedia message, comprising at least one of a written message part, a media charger tag, a network address of the media charger server element, and a unique identifier.

188. The method according to claim 182, wherein the second message portion includes at least one of content data of the multimedia message and a unique identifier.

189. The method according to claim 182, wherein at least one of the transmitting of the first message portion and the transmitting of the second message portion is effected at least in part via an IP based communication path.

190. The method according to claim 182, wherein at least one of the transmitting of the first message portion and the transmitting of the second message portion is effected at least in part via a transmission path including a wireless application protocol.

191. A computer program product for a computer, comprising software code portions for making, when said product is run on the computer, said computer to function as a terminal device configured to send a multimedia message in a communication system, the communication system comprising:
a multimedia message service control element and a media charger server element,
wherein the computer program product is configured to work as:
a media charger proxy functional means which is configured
to process the multimedia message to be transmitted by
dividing the multimedia message into at least a first message portion and a second message portion,
to transmit the first message portion to the multimedia message service control element, and
to transmit the second message portion to the media charger server element.

192. A terminal device configured to receive a multimedia message in a communication system, comprising
a media charger proxy functional means which is configured
to receive a notification of a message transmission system about the transmission of a multimedia message,
to request the transmission of a first message portion from a multimedia message service control element,
to request the transmission of a second message portion from a media charger server element to the receiver terminal, and
to combine the first message portion and the second message portion for obtaining the multimedia message transmitted.

193. The terminal device according to claim 192, wherein each of the first message portion and the second message portion includes a unique identifier.

194. The terminal device according to claim 192, wherein
the media charger proxy functional means of the terminal device is configured to perform requesting the second message portion after the first message portion is received.

195. The terminal device according to claim 192, wherein the first message portion includes a header indicating communication information, obtained from the multimedia message, comprising at least one of a written message part, a media charger tag, a network address of the media charger server element, and a unique identifier.

196. The terminal device according to claim 192, wherein the second message portion includes at least one of content data of the multimedia message and a unique identifier.

197. The terminal device according to claim 192, wherein the terminal device is configured to receive, at least in part, at least one of the first message portion, the second message portion and the notification about the multimedia message via an IP based communication path.

198. The terminal device according to claim 192, wherein the terminal device is configured to receive at least one of the first message portion and the second message portion at least in part via a transmission path including a wireless application protocol.

199. The terminal device according to claim 192, wherein the terminal device is configured to receive at least in part the notification about the multimedia message via a transmission path including a short message service signaling.

200. The terminal device according to claim 192, wherein the terminal device is configured to display the transmitted multimedia message on the basis of the first message portion and the second message portion received.

201. A method for receiving a multimedia message at a terminal device in a communication system, comprising:
receiving a notification of a message transmission system about the transmission of a multimedia message,
requesting the transmission of a first message portion from a multimedia message service control element,
requesting the transmission of a second message portion from a media charger server element to the receiver terminal, and
combining the first message portion and the second message portion for obtaining the multimedia message transmitted.

202. The method according to claim 201, wherein each of the first message portion and the second message portion includes a unique identifier.

203. The method according to claim 201, wherein the receiving of the notification, the requesting of the transmission of the first and second message portions and the combining of the first and second message portions are executed by a media charger proxy functionality.

204. The method according to claim 201, further comprising
performing requesting the second message portion after the first message portion is received.

205. The method according to claim 201, wherein the first message portion includes a header indicating communication information, obtained from the multimedia message, comprising at least one of a written message part, a media charger tag, a network address of the media charger server element, and a unique identifier.

206. The method according to claim 201, wherein the second message portion includes at least one of content data of the multimedia message and a unique identifier.

207. The method according to claim 201, wherein, at least in part, at least one of the receiving of the first message portion, the receiving of the second message portion and the receiving of the notification about the multimedia message is effected via an IP based communication path.

208. The method according to claim 201, wherein at least one of the receiving of the first message portion and the receiving of the second message portion is effected at least in part via a transmission path including a wireless application protocol.

209. The method according to claim 201, wherein the receiving of the notification about the multimedia message is effected at least in part via a transmission path including a short message service signaling.

210. The method according to claim 201, further comprising displaying the transmitted multimedia message on the basis of the first message portion and the second message portion received.

211. A computer program product for a computer, comprising software code portions for making, when said product is run on the computer, said computer to function as a terminal device configured to receive a multimedia message in a communication system, the communication system comprising:
a multimedia message service control element, a media charger server element, and a message transmission system,
wherein the computer program product is configured to work as:
a media charger proxy functional means which is configured
to receive a notification of the message transmission system about the transmission of a multimedia message,
to request the transmission of a first message portion from the multimedia message service control element,
to request the transmission of a second message portion from the media charger server element to the receiver terminal, and
to combine the first message portion and the second message portion for obtaining the multimedia message transmitted.

212. A multimedia message service control element of a communication system for transmitting a multimedia message,
wherein the multimedia message service control element is configured to
to receive from a sender terminal a first message portion related to the multimedia message,
to notify, via a message transmission system, a receiver terminal about the transmission of the multimedia message,
to receive a request from the receiver terminal for transmitting the first message portion, and
to transmit the first message portion related to the multimedia message to the receiver terminal.

213. The multimedia message service control element according to claim 212, wherein the notification of the receiver terminal is executed when the first message portion is received by the multimedia message service control element.

214. The multimedia message service control element according to claim 212, wherein the notification of the receiver terminal is executed when the multimedia message service control element receives an information from the media charger server element that the media charger server element has received a second message portion.

215. The multimedia message service control element according to claim 212, wherein the first message portion includes a header indicating communication information, obtained from the multimedia message, comprising at least one of a written message part, a media charger tag, a network address of the media charger server element, and a unique identifier.

216. The multimedia message service control element according to claim 212, wherein the multimedia message service control element is configured to use, at least in part, an IP based communication path for at least one of transmitting the first message portion and notifying the receiver terminal.

217. The multimedia message service control element according to claim 212, wherein the multimedia message service control element is configured to use at least in part a transmission path including a wireless application protocol for transmitting the first message portion.

218. The multimedia message service control element according to claim 212, wherein the multimedia message service control element is configured to use at least in part a transmission path including a short message service signaling for notifying the receiver terminal.

219. A method for transmitting a multimedia message in a communication system, comprising:
receiving at a multimedia message service control element from a sender terminal a first message portion related to the multimedia message,
notifying via a message transmission system a receiver terminal about the transmission of the multimedia message,
receiving at the multimedia message service control element a request from the receiver terminal for transmitting the first message portion, and
transmitting from the multimedia message service control element the first message portion related to the multimedia message to the receiver terminal.

220. The method according to claim 219, wherein the notifying of the receiver terminal is executed when the first message portion is received by the multimedia message service control element.

221. The method according to claim 219, wherein the notifying of the receiver terminal is executed when the multimedia message service control element receives an information from the media charger server element that the media charger server element has received a second message portion.

222. The method according to claim 219, wherein the first message portion includes a header indicating communication information, obtained from the multimedia message, comprising at least one of a written message part, a media charger tag, a network address of the media charger server element, and a unique identifier.

223. The method according to claim 219, wherein at least one of the transmitting of the first message portion and notifying of the receiver terminal is effected, at least in part, by means of an IP based communication path.

224. The method according to claim 219, wherein the transmitting of the first message portion is effected, at least in part, by means of a transmission path including a wireless application protocol.

225. The method according to claim 219, wherein the notifying about the multimedia message is effected, at least in part, by means of a transmission path including a short message service signaling.

226. A computer program product for a computer, comprising software code portions for making, when said product is run on the computer, said computer to function as a multimedia message service control element of a communication system for transmitting a multimedia message, the communication system comprising:
a sender terminal comprising a media charger proxy functional means, a receiver terminal comprising a media charger proxy functional means, a media charger server element, and a message transmission element
wherein the computer program product is configured to work
to receive from the sender terminal a first message portion related to the multimedia message,
to notify, via the message transmission system, the receiver terminal about the transmission of the multimedia message,
to receive a request from the receiver terminal for transmitting the first message portion, and
to transmit the first message portion related to the multimedia message to the receiver terminal.

227. A multimedia service system for transmitting a multimedia message in a communication system, the communication system comprising:
a sender terminal comprising a media charger proxy functional means and a receiver terminal comprising a media charger proxy functional means,
wherein the multimedia service system comprises a media charger server element, a multimedia message service control element and a message transmission element,
wherein the multimedia service system is configured
to receive from the sender terminal a first message portion at the multimedia message service control element and a second message portion at the media charger server element, the first and second message portions being related to the multimedia message,
to notify, via the message transmission system, the receiver terminal about the transmission of the multimedia message,
to receive, at the multimedia message service control element, a request from the receiver terminal for transmitting the first message portion,
to transmit the first message portion related to the multimedia message and comprising the unique identifier to the receiver terminal,
to receive, at the media charger server element, a request from the receiver terminal for transmitting the second message portion, and
to transmit the second message portion related to the multimedia message to the receiver terminal.

228. The multimedia service system according to claim 227, wherein each of the first and second message portions comprises a unique identifier for the multimedia message.

229. The multimedia service system according to claim 227, wherein the notification of the receiver terminal is executed when the first message portion is received by the multimedia message service control element.

230. The multimedia service system according to claim 227, wherein the media charger server element is configured to send an information to the multimedia message service control element that the second message portion is received, and the multimedia message service control element is configured to notify the receiver terminal when multimedia message service control element receives the information from the media charger server element that the media charger server element has received the second message portion.

231. The multimedia service system according to claim 227, wherein the first message portion includes a header indicating communication information, obtained from the multimedia message, comprising at least one of a written message part, a media charger tag, a network address of the media charger server element, and a unique identifier.

232. The multimedia service system according to claim 227, wherein the second message portion includes at least one of content data of the multimedia message and a unique identifier.

233. The multimedia service system according to claim 227, wherein the multimedia message service control element and the media charger server element are included in one server entity.

234. A method for transmitting a multimedia message by a multimedia service system in a communication system, the communication system comprising:
a sender terminal comprising a media charger proxy functional means and a receiver terminal comprising a media charger proxy functional means,
wherein the multimedia service system comprises a media charger server element, a multimedia message service control element and a message transmission element,
wherein the method comprising
receiving from the sender terminal a first message portion at the multimedia message service control element and a second message portion at the media charger server element, the first and second message portions being related to the multimedia message,
notifying, via the message transmission system, the receiver terminal about the transmission of the multimedia message,
receiving, at the multimedia message service control element, a request from the receiver terminal for transmitting the first message portion,
transmitting the first message portion related to the multimedia message and comprising the unique identifier to the receiver terminal,
receiving, at the media charger server element, a request from the receiver terminal for transmitting the second message portion, and
transmitting the second message portion related to the multimedia message to the receiver terminal.

235. The method according to claim 234, wherein each of the first and second message portions comprises a unique identifier for the multimedia message.

236. The multimedia service system according to claim 234, wherein the notifying of the receiver terminal is executed when the first message portion is received by the multimedia message service control element.

237. The method according to claim 234, further comprising sending an information from the media charger server element to the multimedia message service control element that the second message portion is received, wherein the notifying of the receiver terminal is executed when multimedia message service control element receives the information from the media charger server element that the media charger server element has received the second message portion.

238. The method according to claim 234, wherein the first message portion includes a header indicating communication information, obtained from the multimedia message, comprising at least one of a written message part, a media charger tag, a network address of the media charger server element, and a unique identifier.

239. The method according to claim 234, wherein the second message portion includes at least one of content data of the multimedia message and a unique identifier.

240. The method according to claim 234, wherein the multimedia message service control element and the media charger server element are included in one server entity.
